(19) United States
(12) Patent Application Publication
(10) Pub. No.: US 2026/0213292 A1
(43) Pub. Date: Jul. 23, 2026

(54) METHOD FOR TREATING AN ELECTRONIC WASTE AND RECOVERING VALUABLE METALS AND RARE EARTH ELEMENTS THEREFROM

(71) Applicant: INSTITUT NATIONAL DE LA RECHERCHE SCIENTIFIQUE, Québec (CA)

(72) Inventors: Jean-François BLAIS, Québec (CA); Lan Huong TRAN, Québec (CA); Salmata DIALLO, Québec (CA); Aba Marie Anne-Antoine OTRON, Québec (CA); Kulchaya TANONG, Québec (CA); Louis-César PASQUIER, Québec (CA)

(21) Appl. No.: 19/137,546

(22) PCT Filed: Dec. 13, 2023
(86) PCT No.: PCT/CA2023/051651

§ 371 Date: Jun. 10, 2025

Related U.S. Application Data
(60) Provisional application No. 63/387,420, filed on Dec. 14, 2022.

(51) Int. Cl. H01M 10/54; C22B 1/24; C22B 3/22; C22B 3/44; C22B 7/00; C22B 11/00; C22B 59/00; H01M 6/52

(52) U.S. Cl. CPC H01M 10/54; C22B 1/24; C22B 3/22; C22B 3/44; C22B 7/007; C22B 11/042; C22B 59/00; H01M 6/52

(57) ABSTRACT

There is provided a process for treating electronic waste comprising at least one of spent batteries and electronic waste. The process can comprise the following steps: fragmenting the electronic waste to produce a fragmented waste comprising a metal powder, recovering said powder from the fragmented waste wherein the metal powder can comprise rare earth elements (REEs) and basic metals, leaching the REEs and the basic metals from the metal powder to produce a residual metal-depleted solid, enriched leachates and a secondary leachate, extracting the REEs from a REEs-enriched leachate and the secondary leachate and selectively extracting the basic metals from a basic metal-enriched leachate to produce multiple extracted components, each extracted component comprising at least one of the basic metals. Depending on the composition of the electronic waste to be treated, precious metals can also be recovered from electronic waste.

### TECHNICAL FIELD

The technical field generally relates to the treatment of electronic waste comprising at least one of spent batteries and electronic equipment waste, and more particularly to process implementations including selective leaching and extraction of valuable metals and rare earth elements.

### BACKGROUND

In North America, battery waste and electronic equipment waste management is increasingly becoming an environmental and political concern due to the growing volumes of waste to be managed and the environmental risks associated with the presence of heavy metals (Cd, Zn, Mn, Ni, e.g.) in such waste. Battery waste collected in recovery centers includes different types of batteries, mainly alkaline batteries (Zn—Mn and Zn—C), nickel-cadmium (Ni—Cd) batteries, nickel-metal hydride batteries (Ni-MH), lithium (Li) batteries and sealed lead (Pb) acid batteries.

From 2017 to 2020, more than 26,000 tons of spent batteries were collected in North America. However, most of the battery waste still ends up in landfills or incineration centers even if this waste contains appreciable quantities of potentially recyclable metals and rare earth elements (REE).

Table 1 presents the content of various metals found in a battery waste collected by spent batteries collection centers depending on the battery type, as well as the average proportions of different battery types included in that waste.

TABLE 1
Elemental composition of the batteries powder prepared
using a mixture of the different types of spent batteries

| | Battery types (mg/kg) | | | | | | Mixture |
|---|---|---|---|---|---|---|---|
| Elements | Alkaline | Zn-C | Ni-MH | Ni-Cd | Li-ion | Li-M | (mg/kg) |
| Al | 1112 | 875 | 4976 | 410 | 23055 | 59260 | 1968 |
| Ba | 35.0 | 114 | 2.60 | 13.0 | 31.0 | 56.0 | 41.9 |
| Cd | 2.60 | 1.40 | 2874 | 209985 | 488 | 22.0 | 3777 |
| Co | 11.0 | 48.0 | 31776 | 9380 | 245380 | 170 | 6672 |
| Cu | 124 | 104 | 692 | 22.0 | 149550 | 1735 | 1401 |
| Fe | 4700 | 426 | 2168 | 82610 | 811 | 230110 | 5589 |
| K | 54635 | 559 | 9950 | | | | 38659 |
| Li | | | 565 | 733 | 29870 | 98265 | 626 |
| Mg | | | 1459 | | | | 209 |
| Mn | 361700 | 265720 | 7150 | 494 | 31.0 | 513 | 286846 |
| Na | | | 6179 | | | | 884 |
| Ni | 111 | 116 | 547645 | 335900 | 106 | 227 | 83782 |
| S | 2830 | 2270 | 328 | | 480 | 197110 | 2907 |
| Zn | 239700 | 287160 | 22372 | 1790 | 72.0 | 351 | 209299 |
| REE | | | | | | | |
| La | | | 44715 | | | | 6394 |
| Nd | | | 15501 | | | | 2217 |
| Sm | | | 12465 | | | | 1783 |
| Ce | | | 11146 | | | | 1594 |
| Pr | | | 6282 | | | | 898 |
| Y | | | 1776 | | | | 254 |
| Tb | | | 648 | | | | 92.7 |
| Er | | | 128 | | | | 18.3 |
| Sc | | | 120 | | | | 17.2 |
| Gd | | | 79.1 | | | | 11.3 |
| Eu | | | 66.4 | | | | 9.50 |
| Dy | | | 64.6 | | | | 9.24 |
| Total (REE) | | | 92991 | | | | 13298 |
| Proportion (%) | 68.0 | 15.0 | 14.3 | 1.6 | 0.8 | 0.3 | 100 |

Over the last years, many technologies allowing the treatment of different types of batteries have been developed and some of them are now commercialized. Accurec, American Manganese, Batrec, Ecopilas, Inmetco, Recupyl, Retriev Technologies, Revatech, RMC, Sab Nife, Snam, Solvay, and Umicore are examples of companies exploiting treatment processes at industrial scale.

Since the mid-1990s, e-waste has been recognized as the fastest growing component of solid waste streams. Nowadays, they have achieved an annual growth rate of 3% to 5%. Thus, e-waste reached more than 50 million metric tons (Mt) in 2018. Solving the E-Waste Problem (StEP) estimated at nearly 7 Mt, the amount of electronic waste produced in the United States in 2018 and an average of 11.6 kg of electronic waste per person, on the American continent. The 2017 Academic Branch Report of the United Nations (UN) estimated the value of raw materials contained in e-waste thrown or collected in 2016 at over US $60 billion. Although electronic waste contains certain hazardous components, it also consists of precious metals (Ag, Au, Pd, Pt), strategic metals (Co, In, Li, Mo, Sn), base metals (Al, Cd, Cr, Cu, Fe, Mn, Ni, Pb, Zn) and rare earth elements (ETR lanthanides in addition to Sc and Y), the availability of which is limited on the international markets. Despite the potential revenues, only 15% of electronic waste is recycled.

About twenty patents relating to the recycling of waste batteries by hydrometallurgical and pyrometallurgical processes are listed in Table 2. The low recovery rates of Zn and Mn, the non-recovery of other metals and rare earth elements, as well as unrealistic operating conditions are factors that greatly reduce the industrial application of some of the disclosed processes in these patents. There is indeed a need for a better alternative for the treatment of battery waste solving these issues.

U.S. Pat. No. 8,728,419 1 discloses a process for the recycling of alkaline spent batteries. These batteries are mainly made of steel case batteries, alkaline electrolytes, a mix of manganese oxide, zinc hydroxide, zinc oxide and some carbon. In this process, only a small part of the manganese is soluble while almost all the zinc is soluble in a solution of sulfuric acid maintained at a temperature between 60° C. and 80° C. The resulting slurry is then filtered to obtain a cake containing MnO₂ as well as a leachate containing Mn, Zn and Fe. Iron is removed from the leachate by heating and air oxidation at pH 4. The soluble MnSO₄ found in the leachate is removed as insoluble MnO₂ by adding sodium persulfate at pH 4. The pure solution of ZnSO₄ is then treated by precipitation at pH 10-11 with Na₂CO₃. ZnCO₃ is obtained as a final product. The MnO₂ contained in the cake is mixed with H₂SO₄ and sodium metabisulfite or sulfur dioxide to dissolve Mn(IV) at 60° C. The pH of this solution is then adjusted to 4 and sodium persulfate is added to form a precipitate of gamma manganese dioxide. Although Mn and Zn are effectively retrieved, this process is only intended for the treatment of used alkaline batteries.

An important technology is that of Batenus process disclosed in U.S. Pat. No. 5,575,907 A. This patent describes a process used for the recycling of metals from unsorted spent batteries. The main metals present in the mixture are Mn, Zn, Ni, Cd, Pb and Hg. First, the spent batteries are simply treated by a mechanical method to separate the waste into two fractions: a coarse and a fine fraction. A wet chemical process is then used to recover each metal separately. The fine fraction is almost completely leached during the two leaching steps carried out in the presence of water (first leaching step) and in the presence of diluted sulfuric acid and sulfur dioxide (second leaching step). Then, two cationic exchange resins are used to remove Hg and to recover Cu from the acidic leachate. Next, Zn is extracted by a liquid-liquid extraction step using an organic extraction agent. The solution now free of Cu, Hg and Zn, is treated by a multistage ion exchange step for separating Ni and Cd. Finally, the solution free of Hg, Cu, Zn, Cd and Ni is electrolysed to recover solid MnO₂ by pH adjustment. The Cu, Cd, Zn and Ni are also recovered by electrowinning methods to obtain the final products in metallic forms. This process is not, however, designed for the recovery of rare earth elements, cobalt, and lithium.

European Patent EP 0,620,607 1 discloses a process to recover metals from a mixture of spent batteries. The mixture may contain Zn, Mn, Ni, Cu and Cd in various concentrations. This recycling method focuses on the recovery of Zn and Mn given the interesting market for these two metals. The spent batteries are crushed under a cold dry air stream and the ferrous materials are removed from the non-ferrous metals (Hg, Mn, Zn, Cd and Ni) using a magnetic separation step. The inert materials are then separated from the mineral sludge by flotation. Next, the mineral sludge is treated by leaching using H₂SO₄ in the presence of a reducing agent at a temperature between 4° and 90° C. Then, Cu is recovered from the leachate by cementation. The Ni and Cd are selectively electrodeposited at pH 4.0-5.5 using an electric potential between 1.5 and 5.0 V. Finally, Zn and Mn are simultaneously recovered using an electrowinning process.

Two other processes for the treatment of alkaline batteries (EP 1,454,376 B1) and lithium-based batteries (U.S. Pat. No. 7,820,317 B2) have also been developed. Alkaline batteries are treated with sulfuric acid leaching assisted by ultrasound in the presence of a reducing agent. After the removal of other heavy metal impurities by hot carburizing, the manganese is recovered as manganese carbonate. Zinc is separated as a soluble zinc ammonia complex before being subjected to heating to ultimately obtain a zinc salt. The second patent concerns lithium batteries. The soluble lithium obtained after several treatment steps is suspended in water by adding LiOH, which increases the pH of the solution to 12 before hydrolysis. The lithium can then be recovered in the form of carbonate (Li₂CO₃) by adding gaseous CO₂.

Thus far, no efficient and economically viable known technology allows the recovery of Zn, Mn, Cd, Co, Ni, Li, and REE from a mixture of spent batteries including alkaline, Zn—Carbon, Ni—Cd, Ni-MH, Li-ion, and Li-M batteries without any expensive sorting step. The patent application CA 2,915,371 relates to a process for recovering Zn, Mn, Ni, and Cd from mixed waste batteries. The suggested process also integrates the recovery of lithium in the form of lithium carbonate and/or lithium phosphate downstream of the recovery stages of other metals. In addition, the suggested process includes the recovery of REE concentrates, which may be in the form of a mixed hydroxide and sulphate REE concentrate, of an oxalate REE concentrate or of an oxide REE concentrate.

TABLE 2
Patents listed on hydrometallurgical and pyrometallurgical
processes for recovering metals from waste batteries

| | Type of spent | Recovered | Type of |
|---|---|---|---|
| Patents | batteries | metals | technology^{¹} |
| U.S. Pat. No.8,728,419 B1 | Alcalines | Zn, Mn | H |
| U.S. Pat. No. 8,586,218 B1 | Alcalines | Zn, Mn | H |
| U.S. Pat. No. 8,911,696 B1 | Alcalines | Zn, Mn | H |
| EP 1,454,376 B1 | Alcalines | Zn, Mn | H |
| EP 1,148,571 B1 | Alcalines | Zn, Mn | H |
| U.S. Pat. No. 5,456,992 | Alcalines | Zn, Mn | H |
| U.S. Pat. No. 8,210,456 B2 | Alcalines | Zn, Mn | H |
| U.S. Pat. No. 8,440,153 B2 | Alcalines | Zn, Mn | H |
| U.S. Pat. No. 5,575,907 A | Alcalines, | Zn, Mn, Ni, | H |
| | Ni/Cd | Cd, Cu, Hg | |
| EP 0,620,607 B1 | Alcalines, | Zn, Mn, Ni, | H |
| | Ni/Cd | Cu, Cd | |
| U.S. Pat. No. 8,616,475 B1 | Lithium | Cu, Al, Li, C | H |
| U.S. Pat. No. 8,882,007 B1 | Lithium | Li | H |
| U.S. Pat. No. 7,820,317 B2 | Lithium | Fe, Cu, Li | H |
| U.S. Pat. No. 8,067,107 B2 | Lithium | Li | H |
| U.S. Pat. No. 5,888,463 | Lithium | Li | H |
| U.S. Pat. No. 4,401,463 | Ni/Cd | Ni, Cd | P |
| U.S. Pat. No. 6,228,143 B1 | Ni/Cd | Ni, Cd, Fe | P |
| U.S. Pat. No. 5,437,705 | Ni/Cd | Ni, Cd | P |
| U.S. Pat. No. 8,696,788 B1 | Ni-MH | Ni, La | H |
| U.S. Pat. No. 7,169,206 B2 | Ni-MH, | Co, Ni | P |
| | Ni/Cd, | | |
| | lithium | | |

¹H: Hydrometallurgy; P: Pyrometallurgy.

### SUMMARY

Differences between the process proposed herein and other known processes include 1) the possibility of recovering almost all metals and rare earth elements having grades of commercial value from the battery waste; 2) very high metal recovery yields; and 3) operating conditions adapted to an industrial process (e.g., reasonable consumption of chemicals, short retention time and low temperature) compared to other existing options. The process implementations described herein are designed to be able to recover metals and REE of commercial interest in electronic equipment waste. In particular, the process includes a selective leaching approach to solubilize the REE first, followed by the base metals and, finally, the precious metals. These metals can then be recovered by techniques described herein for the treatment of battery waste.

In accordance with an aspect, there is provided a process for treating electronic waste comprising at least one of spent batteries and electronic equipment waste, the process comprising the steps of fragmenting the electronic waste to reduce a size thereof and produce a fragmented waste comprising a metal powder, recovering the metal powder from the fragmented waste, wherein the metal powder comprises rare earth elements (REEs) and basic metals, leaching the REEs and the basic metals from the metal powder to produce a residual metal-depleted solid and at least one of a REE-enriched leachate and a basic metal-enriched leachate, and extracting the REEs from the REE-enriched leachate to produce a REE-containing component and a secondary leachate, and selectively extracting the basic metals from at least one of the basic metal-enriched leachate and the secondary leachate to produce multiple extracted components, each extracted component comprising at least one of the basic metals.

In some implementations, the basic metals comprise Cd, Co, Cu, Li, Mn, Ni, Zn, or any combinations thereof.

In some implementations, the REEs comprise La, Nd, Sm, Ce, Pr, Y, Tb, Er, Sc, Gd, Eu, Dy, or any combinations thereof.

In some implementations, fragmenting of the electronic waste comprises at least one of crushing or shredding the electronic waste.

In some implementations, recovering the metal powder comprises separating the fragmented waste into a coarse fraction and a fine fraction, the fine fraction comprising the metal powder.

In some implementations, separating the fragmented waste into the coarse fraction and the fine fraction is performed by sieving or screening.

In some implementations, the recovering of the metal powder further includes recycling the coarse fraction as part of the electronic waste to the fragmenting step b).

In some implementations, the fine fraction further comprises a low-density material comprising at least one of plastic and paper and recovering the metal powder further comprises separating the low-density material and a metal fraction from the fine fraction with a gravitational-based method.

In some implementations, separating the low-density material and a metal fraction from the fine fraction with a gravitational-based method comprises injecting air.

In some implementations, the metal fraction comprises a ferrous metal powder, and recovering the metal powder further comprises separating the ferrous metal powder and the metal powder from the metal fraction by magnetic separation.

In some implementations, leaching of the REEs and the basic metals from the metal powder comprises simultaneously leaching the REEs and the basic metals by contacting the metal powder with a leaching solution to solubilize at least a portion of both the REEs and the basic metals, and to produce a first solid-liquid mixture comprising the REE-enriched leachate and the metal-depleted residual solid, and separating the REE-enriched leachate and the metal-depleted residual solid by solid-liquid separation, wherein the REE-enriched leachate further comprises the basic metals.

In some implementations, the leaching solution comprises an inorganic acid.

In some implementations, the inorganic acid is selected from a group consisting of sulfuric acid (H₂SO₄), hydrochloric acid (HCl) and nitric acid (HNO₃), preferably sulfuric acid.

In some implementations, the inorganic has an acid concentration between 0.5 N and 5 N.

In some implementations, the leaching of REEs comprises a leaching time of about 15 to 120 min, and preferably using a leaching time of about 30 min.

In some implementations, a ratio of a weight of the metal powder to a volume of the leaching solution is between 50 g/L and 200 g/L.

In some implementations, the leaching solution further comprises hydrogen peroxide, sodium metabisulfite, or a combination thereof.

In some implementations, the electronic waste consists of the spent batteries.

In some implementations, leaching of the REEs and the basic metals from the metal powder comprises selectively leaching the REEs and the basic metals.

In some implementations, selectively leaching the REEs and the basic metals comprises leaching the REEs prior to leaching the basic metals.

In some implementations, the leaching of the REEs comprises contacting the metal powder with a first leaching solution to solubilize at least a portion of the REEs and to produce a first solid-liquid mixture comprising the REE-enriched leachate and a REE-depleted residual solid and separating the REE-enriched leachate and the REE-depleted residual solid by solid-liquid separation.

In some implementations, the first leaching solution comprises an inorganic acid.

In some implementations, the inorganic acid is selected from a group consisting of sulfuric acid (H₂SO₄), hydrochloric acid (HCl) and nitric acid (HNO₃).

In some implementations, the inorganic acid is a used acid or a recycled acid.

In some implementations, the first leaching solution has an acid concentration between 0.2 N and 1 N.

In some implementations, leaching the REEs is carried out at a temperature of about 5 to 95° C., and preferably at a temperature of about 20° C.

In some implementations, a ratio of a weight of the metal powder to a volume of the first leaching solution is between 50 g/L and 200 g/L.

In some implementations, a ratio of a weight of the metal powder to a volume of the leaching solution is 100 g/L.

In some implementations, leaching of the basic metals comprises contacting the REE-depleted residual solid with a second leaching solution to solubilize at least a portion of the basic metals and to produce a second solid-liquid mixture comprising the basic metal-enriched leachate and the metal-depleted residual solid, and separating the basic metal-enriched leachate and the metal-depleted residual solid by solid-liquid separation.

In some implementations, the second leaching solution comprises an inorganic acid and an oxidizing agent.

In some implementations, the oxidizing agent comprises hydrogen peroxide.

In some implementations, the second leaching solution comprises an amount of oxidizing agent being stoichiometrically sufficient to oxidize the basic metals present in metallic form in the metal powder.

In some implementations, the second leaching solution has an acid concentration between 1 N and 5 N.

In some implementations, the second leaching solution has an acid concentration of 2 N.

In some implementations, the second leaching solution has a weight ratio of the oxidizing agent to the REE-depleted residual solid between 0.33 and 1.33.

In some implementations, a ratio of a weight of the REE-depleted residual solid to a volume of the second leaching solution is between 50 g/L and 200 g/L.

In some implementations, the metal powder further comprises precious metals, and the process further comprises leaching the precious metals from the metal-depleted residual solid to produce a precious metal-enriched leachate and a metal concentrate.

In some implementations, the leaching of the precious metals comprises contacting the metal-depleted residual solid with a third leaching solution to solubilize at least a portion of the precious metals and to produce a third solid-liquid mixture comprising the precious metal-enriched leachate and the metal concentrate and separating the precious metal-enriched leachate and the metal concentrate by solid-liquid separation.

In some implementations, the third leaching solution has the same composition as the second leaching solution.

In some implementations, the third leaching solution comprises a thiourea solution, a thiosulfate solution, a cyanide solution, or any mixtures thereof.

In some implementations, the third leaching solution has a leaching agent concentration being between 0.10 and 0.50 grams of leaching agent per gram of the metal-depleted residual solid.

In some implementations, the third leaching solution further comprises an oxidant in an amount stoichiometrically sufficient to oxidize the precious metals in metallic form.

In some implementations, the third leaching solution has an oxidant concentration being at most 0.10 grams of oxidant per gram of the metal-depleted residual solid.

In some implementations, the oxidant is a ferric ion salt.

In some implementations, leaching of the precious metal is performed according to a solids content between 50 and 200 grams of the metal-depleted residual solid per liter of the third leaching solution.

In some implementations, the third leaching solution further comprises an inorganic acid.

In some implementations, the third leaching solution has an acid concentration between 0.1 N and 0.5 N.

In some implementations, the process further comprises extracting the precious metals from the precious metal-enriched leachate to produce a precious metals concentrate and a recyclable effluent.

In some implementations, extracting of the precious metals from the precious metal-enriched leachate comprises using at least one of activated carbon adsorption, cementation, ion-exchange, or electrodeposition.

In some implementations, the precious metals comprise gold (Au), silver (Ag), platinum group metals (PGMs), and any combinations thereof.

In some implementations, the electronic waste comprises the spent batteries and the electronic equipment waste.

In some implementations, extracting of the REEs comprises precipitating REE-hydroxides and/or REE-sulfates by adding a base solution to the REE-enriched leachate to produce a fourth solid-liquid mixture comprising the REE-containing component and the secondary leachate, wherein the REE-containing component comprises the REE-hydroxides and/or REE-sulfates, and separating the REE-containing component and the secondary leachate by solid-liquid separation.

In some implementations, extracting of the REEs comprises precipitating REE-hydroxides and/or REE-sulfates by adding a base solution to the metal-enriched leachate to produce a fourth solid-liquid mixture, separating the REE-hydroxides and/or the REE-sulfates from the fourth solid-liquid mixture via solid-liquid separation, re-dissolving the REE-hydroxides and/or the REE-sulfates in an acid solution to form a REE-containing solution, and precipitating REE-oxalates by adding an oxalic acid and/or an oxalate salt to the REE-containing solution to produce a fifth solid-liquid mixture comprising the REE-oxalates, and separating the REE-oxalates from the fifth solid-liquid mixture as the REE-containing component via solid-liquid separation.

In some implementations, the base solution is selected from a group consisting of sodium hydroxide (NaOH), potassium hydroxide (KOH), calcium hydroxide (Ca(OH)₂) and magnesium hydroxide (Mg(OH)₂).

In some implementations, the base solution further comprises a sulfate salt.

In some implementations, extracting of the REEs comprises precipitating REE-oxalates by adding a sulfate salt to the REE-enriched leachate to produce a fourth solid-liquid mixture comprising the REE-oxalates and the secondary leachate, and separating the REE-oxalates and the secondary leachate from the fourth solid-liquid mixture via solid-liquid separation as the REE-containing component.

In some implementations, the sulfate salt is sodium sulfate (Na₂SO₄), potassium sulfate (K₂SO₄), or any mixtures thereof.

In some implementations, the process further comprises calcining the REE-containing component to produce REE oxides.

In some implementations, the process further comprises mixing the basic-metal enriched leachate and the secondary leachate to form a metal-enriched leachate, and wherein the selective extracting of the basic metals is performed from the metal-enriched leachate.

In some implementations, selectively extracting the basic metals comprises successively extracting each one of the basic metals to produce each extracted component comprising one basic metal.

In some implementations, the basic metals comprise copper, zinc, cadmium, manganese, cobalt, nickel and lithium, and the multiple extracted components successively produced by the selective extracting of the copper, zinc, cadmium, manganese, cobalt, nickel and lithium comprise metallic copper (Cu), metallic zinc (Zn), metallic cadmium (Cd), a cadmium sulfide concentrate (CdS), a manganese carbonate concentrate (MnCO₃), a cobalt oxide concentrate (CoO), a nickel oxide concentrate (NiO), lithium carbonate (LiCO₃) and lithium phosphate (Li₃PO₄).

In some implementations, the electronic waste comprises spent batteries and the process further comprises inerting the spent batteries prior to fragmenting the electronic waste.

In some implementations, inerting of the spent batteries comprises placing the spent batteries in an aqueous saline or acidic solution, freezing the spent batteries using liquid nitrogen, or a combination thereof.

In some implementations, the leaching of the REEs and the basic metals from the metal powder comprises performing multiple successive acid leaching steps of the REEs and the basic metals.

In some implementations, the leaching of the REEs and the basic metals from the metal powder comprises performing at least one acid leaching of the REEs and basic metals and at least one washing of the metal-depleted residual solid with water.

In accordance with another aspect, there is provided a process for treating spent batteries comprising basic metals and rare earth elements (REE), the process comprising the steps of inerting the spent batteries, fragmenting the spent batteries to reduce a size of thereof and produce a fragmented waste including a metal powder, recovering the metal powder from the fragmented waste, wherein the metal powder comprises the REEs and the basic metals, simultaneously leaching the REEs and the basic metals by contacting the metal powder with a leaching solution to solubilize at least a portion of both the REEs and the basic metals, and to produce a first solid-liquid mixture comprising a leachate and a metal-depleted residual solid, wherein the leachate comprises both the REEs and the basic metals, separating the leachate and the metal-depleted residual solid by solid-liquid separation, extracting the REEs from the leachate to produce a REE-containing component and a secondary leachate, wherein the secondary leachate comprises the basic metals, selectively extracting the basic metals from the secondary leachate to produce multiple extracted components, each extracted component comprising at least one of the basic metals.

In some implementations, the inerting of the spent batteries comprises one of placing the spent batteries in an aqueous saline or acidic solution or freezing the spent batteries using liquid nitrogen.

In some implementations, the fragmenting of the spent batteries is performed in a non-oxidizing environment.

In some implementations, the non-oxidizing environment comprises a nitrogen atmosphere.

In some implementations, the process for the treatment of spent batteries further comprises at least one feature of some of the implementations described herein with respect to the treatment of an electronic waste comprising electronic equipment waste.

In some implementations, the spent batteries are selected from the group consisting of alkaline Zn/MnO₂ batteries, Zn—C batteries, Ni—Cd batteries, Ni-MH batteries, Li-ion batteries, Li-M batteries, button cells, and any combinations thereof.

In some implementations, the electronic equipment waste comprises equipment pieces selected from the group consisting of laptops, televisions, CRT monitors, LCD monitors, LED monitors, cell phones, smartphones, electronic tablets, solar photovoltaic (PV) panels, traditional hard drives (HDD), solid-state drives (SSD), and any combinations thereof.

In some implementations, selectively extracting Cu comprises adjusting the pH of the metal-enriched leachate by adding a base, adding a first organic solvent to create an aqueous-organic solution composed of an aqueous phase and an organic phase, extracting Cu from the aqueous phase to create a Cu-depleted aqueous solution and a Cu-rich organic solution, separating the Cu-depleted aqueous solution from the Cu-rich organic solution, stripping Cu from the Cu-rich organic solution forming a Cu-depleted organic phase, and electrodepositing Cu on a cathode to form the extracted component comprising Cu, wherein the base is sodium hydroxide.

In some implementations, the first organic solvent is composed of 45% (v/v) of a mixed aldoxime-ketoxime reagent (e.g., LIX 84-I), and 55% (v/v) of kerosene.

In some implementations, extracting Cu from the aqueous phase comprises two stages of organic solvent extraction with an organic phase volume to aqueous phase volume ratio of 1.

In some implementations, separating the Cu-depleted aqueous solution from the Cu-rich organic solution is carried out by decantation.

In some implementations, stripping Cu from the Cu-rich organic solution comprises adding a H₂SO₄ solution in a ratio of Cu-rich organic solution to H₂SO₄ solution of 1 and obtaining a CuSO₄ solution and the Cu-depleted organic phase and separating the CuSO₄ solution from the Cu-depleted organic phase.

In some implementations, electrodepositing Cu contained in the CuSO₄ solution on a cathode comprises using a Ti/IrO₂ anode, a stainless-steel cathode, and a current density of 360 A/m² and producing an effluent to recycle and electrodeposited Cu.

In some implementations, selectively extracting Zn comprises adjusting the pH of the Cu-depleted aqueous solution by adding the base, adding a second organic solvent to create a second aqueous-organic solution composed of an aqueous phase and an organic phase, extracting Zn from the aqueous phase to create a Zn-depleted aqueous solution and a Zn-rich organic solution, separating the Zn-depleted aqueous solution from the Zn-rich organic solution, stripping Zn from the Zn-rich organic solution, and electrodepositing Zn on a cathode.

In some implementations, the second organic solvent is composed of 20 to 30% (v/v) bis/2,4,4-trimethylpentyl/phosphinic acid (Cyanex 272), 2% (v/v) of tri-butyl phosphate (TBP) and 68 to 78% (v/v) of kerosene.

In some implementations, extracting Zn from the aqueous phase comprises two stages of organic solvent extraction with an organic phase volume to aqueous phase volume of 2.

In some implementations, separating Zn-depleted aqueous solution from the Zn-rich organic solution is carried out by decantation.

In some implementations, stripping Zn from the Zn-rich organic solution comprises adding a H₂SO₄ solution in a ratio of Zn-rich organic solution volume to H₂SO₄ solution volume of 2 and obtaining a ZnSO₄ solution and a Zn-depleted organic phase, stripping residual iron from the Zn-depleted organic phase to form a resulting iron solution and separating said solution from the Zn-depleted organic phase.

In some implementations, stripping residual iron comprises forming a FeSO₄ solution.

In some implementations, separating the iron solution from the Zn-depleted organic phase is carried out by decantation.

In some implementations, electrodepositing Zn on a cathode comprises using a Ti/IrO₂ anode, a stainless-steel or aluminum cathode, and a current density between 250 and 750 A/m² and producing an effluent to recycle and electrodeposited Zn.

In some implementations, selectively extracting Cd and Mn comprises adjusting the pH of the Zn-depleted aqueous solution by adding the base, adding a third organic solvent to create a third aqueous-organic solution composed of an aqueous phase and an organic phase, extracting Cd and Mn from the aqueous phase to create a Cd-Mn-depleted aqueous solution and a Cd-Mn-rich organic solution, separating the Cd-Mn-depleted aqueous solution from the Cd-Mn-rich organic solution, scrubbing the Cd-Mn-rich organic solution, stripping Cd and Mn from the Cd-Mn-rich organic solution, electrodepositing Cd on a cathode, separating a Mn solution and treating the Mn solution.

In some implementations, the third organic solvent is composed of 30% (v/v) of Di-(2-ethylhexyl) phosphoric acid (D2EHPA), 5% (v/v) of TBP and 65% (v/v) of kerosene.

In some implementations, extracting Cd and Mn from the aqueous phase comprises two stages of organic solvent extraction with an organic phase volume to aqueous phase volume of 2.

In some implementations, separating Cd-Mn-depleted aqueous solution from the Cd-Mn-rich organic solution is carried out by decantation.

In some implementations, scrubbing the Cd-Mn-rich organic solution comprises adding a H₂SO₄ solution in an Cd-Mn-rich organic solution volume to H₂SO₄ solution volume ratio of 20 and removing impurities.

In some implementations, stripping Cd and Mn from the Cd-Mn-rich organic solution comprises adding a H₂SO₄ solution in a ratio of Cd-Mn-rich organic solution volume to H₂SO₄ solution volume of 4 to the Cd-Mn-rich organic solution and obtaining a Cd-Mn-sulfate solution.

In some implementations, electrodepositing Cd comprises using a Ti/IrO₂ anode, a stainless-steel or aluminum cathode, and a current density between 360 and 370 A/m² and producing electrodeposited Cd and the Mn solution.

In some implementations, stripping Cd and Mn from the Cd-Mn-rich organic solution comprises precipitating Cd as a cadmium sulfide (CdS) concentrate from the Cd-Mn-rich organic solution by adding a first base and a sulfide salt to the Cd-Mn-rich organic solution and separating the CdS from a waste stream.

In some implementations, separating the CdS concentrate is carried out by using solid-liquid separation.

In some implementations, the sulfide salt is NaHS or Na₂S.

In some implementations, the Mn solution is a MnSO₄ solution.

In some implementations, treating the Mn solution comprises precipitating MnCO₃ by adding a first base and a carbonate salt and separating the MnCO₃ from a waste stream.

In some implementations, the first base is selected from a group consisting of sodium hydroxide (NaOH), potassium hydroxide (KOH), calcium hydroxide (Ca(OH)₂) and magnesium hydroxide (Mg(OH)₂).

In some implementations, separating the MnCO₃ is carried out by using the solid-liquid separation.

In some implementations, the carbonate salt is Na₂CO₃ or K₂CO₃.

In some implementations, selectively extracting Co and Ni comprises adjusting the pH of the Cd-Mn-depleted aqueous solution by adding the base, adding a fourth organic solvent to create a fourth aqueous-organic solution composed of an aqueous phase and an organic phase, extracting Co and Ni from the aqueous phase to create a Co-Ni-depleted aqueous solution and a Co-Ni-rich organic solution, separating the Cd-Mn-depleted aqueous solution from the Cd-Mn-rich organic solution, scrubbing the Co-Ni-rich organic solution to eliminate Ni from the Co-Ni-rich organic solution and create a Co-rich organic solution and a Co-depleted aqueous solution, stripping Co from the Co-rich organic solution, precipitating Co to form a Co oxalate precipitate by adding a oxalate salt or oxalic acid, separating the Co oxalate precipitate to form a Co oxalate concentrate, calcinating the Co oxalate concentrate to obtain Co oxides (CoO) and treating the Co-depleted aqueous solution.

In some implementations, the fourth organic solvent is composed of 10% (v/v) of Bis/2,4,4-trimethylpentyl/phosphinic acid (Cyanex 272), 2% (v/v) of TBP and 88% (v/v) of kerosene.

In some implementations extracting Co and Ni from the aqueous phase comprises two stages of organic solvent extraction with an organic phase volume to aqueous phase volume of 0.5.

In some implementations, separating Co-Ni-depleted aqueous solution from the Cd-Mn-rich organic solution is carried out by decantation.

In some implementations, scrubbing the Co-Ni-rich organic solution comprises adding CoSO₄ to obtain a Co-Ni-rich organic solution volume to CoSO₄ volume ratio of 4 and separating the Co-rich organic solution from the Co-depleted aqueous solution.

In some implementations, stripping Co from the Co-rich organic solution comprises adding a H₂SO₄ solution in a Co-rich organic solution volume to H₂SO₄ solution volume ratio of 2 to form a CoSO₄ solution.

In some implementations, precipitating Co comprises adding an oxalate salt or oxalic acid to the CoSO₄ solution to form the Co oxalate precipitate.

In some implementations, separating the Co oxalate precipitate is carried out using the solid-liquid separation.

In some implementations, treating the Co-depleted aqueous solution comprises precipitating Ni oxalate by adding an oxalate salt or oxalic acid, separating the Ni oxalate from a Co-Ni-depleted solution by using the solid-liquid separation and calcinating the Ni oxalate to obtain Ni oxides (NiO).

In some implementations, selectively extracting LiCO₃ and Li₃PO₄ comprises precipitating metal hydroxides in the Co-Ni-depleted solution by adding a second base solution, separating the metal hydroxides from a resulting lithium sulfate solution, precipitating LiCO₃ by adjusting the pH to a pH between 9 and 10 using the second base and adding a carbonate salt or a concentrated solution of a carbonate salt, separating the LiCO₃ from a LiCO₃-depleted solution, precipitating Li₃ PO₄ by adding a phosphate salt to the LiCO₃-depleted solution and separating Li₃ PO₄ from a lithium-depleted solution.

In some implementations the second base solution is selected from a group consisting of sodium hydroxide (NaOH), potassium hydroxide (KOH), calcium hydroxide (Ca(OH)₂) and magnesium hydroxide (Mg(OH)₂).

In some implementations, separating the metal hydroxides from the resulting lithium sulfate solution is carried out using the solid-liquid separation.

In some implementations, the carbonate salt is sodium carbonate (Na₂CO₃) or potassium carbonate (K₂CO₃).

In some implementations, separating the LiCO₃ and separating Li₃ PO₄ from a lithium-depleted solution are carried out using the solid-liquid separation.

In some implementations, the phosphate salt is sodium phosphate (Na₃PO₄).

In some implementations, extracting Li₃PO₄ is performed without extracting LiCO₃.

In some implementations, the residual metal-depleted solid is a magnesium dioxide (MnO₂) concentrate.

In some implementations, the REE-containing component is an REE oxide concentrate.

In some implementations, the fragmenting comprises crushing and/or shredding the fine fraction until a particle size of less than 5 mm is obtained.

In some implementations, recovering the metal powder further comprises an attrition treatment step using water.

In some implementations, the attrition treatment step is carried out by vigorously mixing a solution containing 30 to 70% of fine fraction in water during a period of about 2 to 15 min.

In some implementations, the solid-liquid separation is selected from a group consisting of filtration, centrifugation and settling techniques.

In some implementations, metal-depleted residual solid is treated by successive leaching steps with acid or washed with water.

In some implementations, leaching the REEs and the basic metals comprises using a counter-current washing process or a counter-current leaching process to reduce the volume of REE-enriched leachate.

In some implementations, the process further comprises washing the fine fraction prior leaching.

In some implementations, the leaching of the REEs and basic metals is performed at a temperature of about 5 to 95° C., and preferably at a temperature of about 20° C. for REE solubilization.

In some implementations, the leaching of the REEs and basic metals comprises using a leaching time of about 15 to 120 min, and preferably using a leaching time of about 30 min for REE solubilization.

In some implementations, the leaching of the REEs and basic metals comprises using a leaching time of about 60 to 360 min, and preferably using a leaching time of about 180 min for basic metals solubilization.

In some implementations, the leaching of the precious metals comprises using a temperature of 5 to 95° C., and preferably at a temperature of about 20° C. for precious metals solubilization.

In some implementations, the leaching of the precious metals comprises using a thiourea concentration of about 0.10 to 0.50 g/g of metal-depleted residual solid, and preferably using a thiourea concentration of about 0.25 g/g of metal-depleted residual solid for precious metals solubilization.

In some implementations, the leaching of the precious metals comprises using a leaching time of about 30 to 240 min, and preferably using a leaching time of about 120 min for precious metals solubilization.

In some implementations, the leaching of the precious metals comprises proceeding with a solids concentration of about 50 to 200 g of metal-depleted residual solid per liter of solution, and preferably proceeding with a metal-depleted residual solid concentration of about 130 g per liter of solution for precious metals solubilization.

In some implementations, precipitating REE-hydroxides and/or REE-sulfates is carried out at a pH of at least 1.2, and preferably at pH of about 1.5.

In some implementations, precipitating REE-hydroxides and/or REE-sulfates is carried out at a temperature of 5 to 95° C., and preferably at a temperature of about 20° C.

In some implementations, precipitating REE-hydroxides and/or REE-sulfates is carried out using a precipitation time of about 5 to 60 min, and preferably using a precipitation time of about 10 min.

In some implementations, re-dissolving the REE-hydroxides and/or the REE-sulfates comprises using a hydrochloric acid solution.

In some implementations, precipitating REE-oxalates is performed at a pH of about 0.75.

In some implementations, precipitating REE-oxalates is performed at a temperature of about 5 to 95° C., and preferably at a temperature of about 20° C.

In some implementations, precipitating REE-oxalates comprises using a precipitation time of about 5 to 60 min, and preferably using a precipitation time of about 10 min.

In some implementations, precipitating REE-oxalates is carried out without the precipitation of REE hydroxides and REE sulfates.

In some implementations, extracting Cu from the aqueous phase using a first organic solvent is carried at a pH of about 2.

In some implementations, stripping Cu from the Cu-rich organic solution comprises using the H₂SO₄ solution at a concentration of 0.5 N and 5 N.

In some implementations, extracting Cu from the aqueous phase is performed at a temperature of about 20° C. to 60° C., and preferably at a temperature of about 20° C.

In some implementations, stripping Cu from the Cu-rich organic solution comprises using a contact time of about 10 min.

In some implementations, electrodepositing Cu on a cathode is carried out at a pH of about 2 and at a temperature of about 20° C. to 60° C., and preferably at a temperature of about 20° C.

In some implementations, electrodepositing Cu on a cathode is carried out using a contact time of about 120 min.

In some implementations, extracting Zn from the aqueous phase is carried out at a pH of about 2.0 to 2.5.

In some implementations, extracting Zn from the aqueous phase is carried out at a temperature of about 40° C. to 60° C., and preferably at a temperature of about 50° C.

In some implementations, stripping Zn from the Zn-rich organic solution comprises using the H₂SO₄ solution at a concentration of 2 N.

In some implementations, stripping Fe from the Zn-rich organic solution comprises using the H₂SO₄ solution at a concentration of 2 N and a ratio of Zn-rich organic solution volume to H₂SO₄ solution volume of 2.

In some implementations, stripping Fe from the Zn-rich organic solution comprises using a contact time of about 10 min.

In some implementations, electrodepositing Zn is carried out at pH of about 2.0 and at a temperature of about 40° C. to 60° C., and preferably at a temperature of about 50° C.

In some implementations, electrodepositing Zn comprises using a contact time of about 120 to 180 min.

In some implementations, extracting Cd and Mn from the aqueous phase is carried out at pH of about 2.7 to 2.9 and a temperature of about 40° C. to 60° C., and preferably at a temperature of about 50° C.

In some implementations, scrubbing the Cd-Mn-rich organic solution is performed at an equilibrium pH of about 2.3.

In some implementations, stripping Cd and Mn from the Cd-Mn-rich organic solution comprises using a H₂SO₄ solution of about 0.5 to 0.6 N concentration.

In some implementations, stripping Cd and Mn from the Cd-Mn-rich organic solution comprises using a contact time of about 10 min.

In some implementations, electrodepositing Cd on a cathode is carried out at a pH of about 2.0 and a temperature of about 40° C. to 60° C., and preferably at a temperature of about 50° C.

In some implementations, electrodepositing Cd on a cathode is carried out using a contact time of about 120 to 240 min.

In some implementations, precipitating Mn is carried at a at pH of about 8 to 9 and at room temperature.

In some implementations, precipitating Mn comprises using a retention time of about 15 to 240 min.

In some implementations, extracting Co and Ni from the aqueous phase is carried out at a pH of about 5.2 to 5.5. and at a temperature of about 40° C. to 60° C., and preferably at a temperature of about 50° C.

In some implementations, stripping Co from the Co-rich organic solution comprises using the H₂SO₄ solution at a concentration of 0.25 N.

In some implementations, stripping Co from the Co-rich organic solution comprises using a contact time of 10 min.

In some implementations, precipitating Co to form a Co oxalate precipitate comprises using a retention time of about 15 to 240 min.

In some implementations, precipitating Co to form a Co oxalate precipitate is performed at room temperature.

In some implementations, precipitating Ni oxalate comprises using a retention time of about 15 to 240 min.

In some implementations, precipitating Ni oxalate is performed at room temperature.

In some implementations, precipitating metal hydroxides in the Co-Ni-depleted solution is carried out at a pH of about 7 to 10.

In some implementations, precipitating LiCO₃ is carried out at a temperature of about 0° C. to 100° C., and preferably at a temperature of about 50° C.

In some implementations, precipitating LiCO₃ comprises using a retention time of about 45 min.

While the present techniques will be described in conjunction with example embodiments, it will be understood that it is not intended to limit the scope of the invention to such embodiments. On the contrary, it is intended to cover all alternatives, modifications and equivalents as may be included as defined by the present description. The objects, advantages and other features of the present techniques will become more apparent and be better understood upon reading of the following non-restrictive description of the invention, given with reference to the accompanying drawings.

### BRIEF DESCRIPTION OF THE DRAWINGS

The attached figures illustrate various features, aspects and implementations of the technology described herein.

FIG. 1 is a schematic process flow diagram of the general steps for fragmenting an electronic waste into a fragmented waste and recovering a metal powder therefrom.

FIG. 2 is a schematic process flow diagram of the general steps for leaching both rare earth elements and basic metals from the metal powder, thereby producing a REE-enriched leachate comprising basic metals and rare earth elements.

FIG. 3 is a schematic process flow diagram of the general steps for selectively leaching the rare earth elements, the basic metals, and the precious metals from the metal powder, thereby producing a REE-enriched leachate, a basic metal-enriched leachate, and a precious metal-enriched leachate.

FIG. 4 is a schematic process flow diagram of the general steps for extracting the rare earth element from the REE-enriched leachate, thereby producing a secondary leachate.

FIG. 5 is a schematic process flow diagram of the general steps for selectively extracting basic metals from the at least one of the basic metal-enriched leachate and secondary leachate to recover multiple extracted components.

FIG. 6 is a schematic process flow diagram of the general steps for extracting metallic copper from at least one of the secondary leachate and the basic metal-enriched leachate and produce a Cu-depleted solution.

FIG. 7 is a schematic process flow diagram of the general steps for extracting metallic zinc from the Cu-depleted solution and produce a Zn-depleted solution.

FIG. 8 is a schematic process flow diagram of the general steps for extracting metallic cadmium from the Zn-depleted solution and produce a MnSO₄ solution.

FIG. 9 is a schematic process flow diagram of the general steps for extracting manganese as a MnCO₃ component from the MnSO₄ solution and produce a Mn-depleted solution.

FIG. 10 is a schematic process flow diagram of the general steps for extracting cobalt from the Mn-depleted solution as a CoO component and produce a Co-depleted solution.

FIG. 11 is a schematic process flow diagram of the general steps for extracting nickel from the Co-depleted solution as a NiO component and produce a tertiary leachate.

FIG. 12 is a schematic process flow diagram of the general steps for extracting lithium from the tertiary leachate in the form of lithium carbonate (Li₂CO₃) and/or lithium phosphate (Li₃PO₄) and produce an effluent to recycle.

FIG. 13 is a schematic process flow diagram of the general steps for extracting precious metals from a precious metals leachate in the form of a precious metals concentrate and produce an effluent to recycle.

### DETAILED DESCRIPTION

The present techniques provide an electronic waste treatment solution that allows combining different sources of electronic waste without the need to sort the waste.

For example, the electronic waste can be a mixture of unsorted spent batteries, various used electronic equipment parts, or a combination thereof. The present techniques further allow tailoring the process in accordance with the nature of the electronic waste to extract and recover selectively at least both basic metals and rare earth elements (RREs).

Precious metals, when present, can further subsequently be extracted and recovered. The basic metals, RREs, and precious metals are recovered as multiple extracted components that can be the element in metallic form (e.g., metallic copper), or include the element in complexed, oxidized, or carbonated form (e.g., NiO, CoCO₃). It is to be noted that the extracted components can be directly valorised for use in secondary processes, thereby reducing or avoiding the disposal of toxic metals in landfill sites.

In some implementations, the spent batteries can be selected from the group consisting of alkaline Zn/MnO₂ batteries, Zn—C batteries, Ni—Cd batteries, Ni-MH batteries, Li-ion batteries, Li-M batteries, and any combinations thereof. The electronic equipment waste can comprise equipment pieces selected from the group consisting of laptops, televisions, CRT monitors, LCD monitors, LED monitors, cell phones, smartphones, electronic tablets, solar photovoltaic (PV) panels, traditional hard drives (HDD), solid-state drives (SSD), and any combinations thereof.

General steps of the processes proposed herein include production of a metal powder from the electronic waste, selective leaching of the RREs, basic metals, and precious metals (when present) to recover multiple metal-enriched leachates, and then selective extraction of the RREs, basic metals, and precious metals (when present) under the form of multiple extracted components.

### Production and Recovery of the Metal Powder

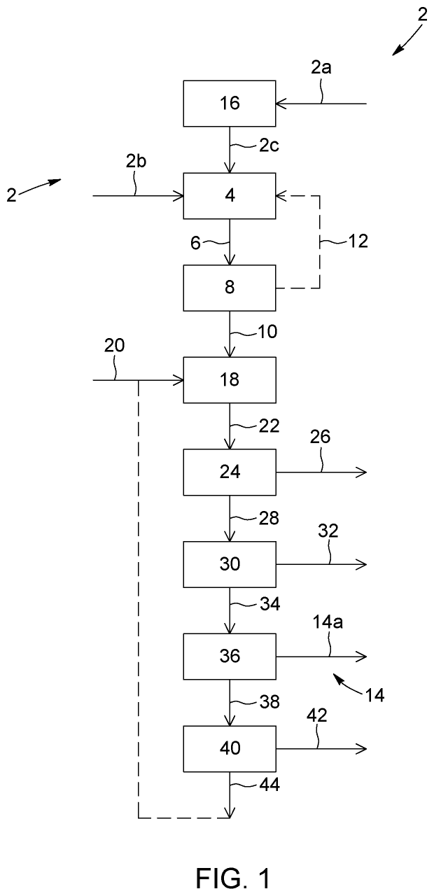

As seen in FIG. 1, production of the metal powder includes fragmenting 4 the electronic waste 2 to reduce a size thereof and produce a fragmented waste 6 including the metal powder. The metal powder can be recovered in a fine fraction 10 that results from the separation 8 of the fragmented waste 6 into a coarse fraction 12 and the fine fraction 10. It should be further noted that the fine fraction 8 of the fragmented waste 6 can further include a low-density material and ferrous metal.

The low-density material can include at least one of plastic and paper. The ferrous metal in the fine fraction 10 can be present as iron scraps. The low-density material and ferrous metal can be separated from the fine fraction 10 to recover the metal powder separately according to techniques further described herein or any other conventional separation techniques as known in the field.

The metal powder that is recovered from the fine fraction 10 of the fragmented waste 6 includes basic metals, REEs, and optionally the precious metals. More particularly, when the electronic waste 2 consists of or comprise a mixture of spent batteries including alkaline batteries, Zn—C batteries, Ni—Cd batteries, Ni-MH batteries, Li-ion batteries, Li-M batteries, or any combinations thereof, the metal powder can include basic metals and REEs. Basic metals as referred herein include Al, Ba, Cd, Co, Cu, Fe, K, Li, Mg, Mn, Na, Ni, S, Zn, or any combinations thereof. When referring to “basic metals”, one should understand that reference is made to one or more metal(s) of this category.

REEs as referred to herein include La, Nd, Sm, Ce, Pr, Y, Tb, Er, Sc, Gd, Eu, Dy or any combinations thereof. When referring to “REEs”, one should understand that reference is made to one or more metal(s) of this category. When the electronic waste further comprises used electronic equipment parts, the metal powder can further include precious metals. The precious metals as referred to herein include Ag, Au, Pd, Pt, or any combinations thereof. When referring to “precious metals”, one should understand that reference is made to one or more metal(s) compound of this category.

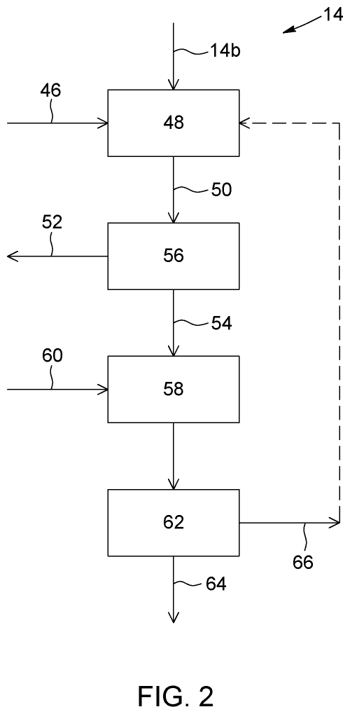

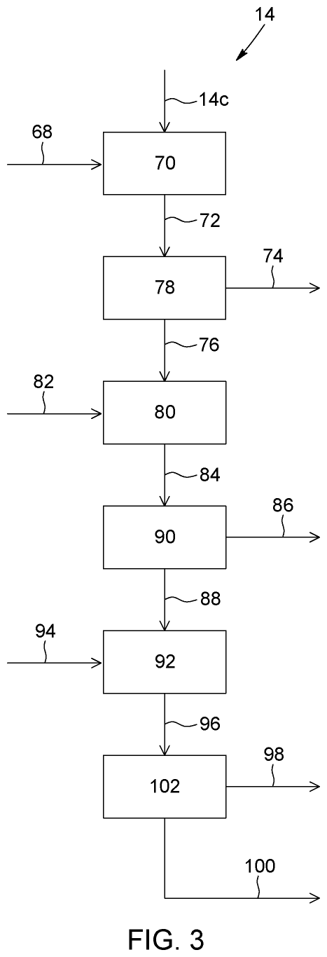

As seen in FIG. 1, the metal powder 14 can be referred to as a batteries and electronics powder 14a when the electronic waste 2 to be treated includes both the unsorted spent batteries 2a and the electronic equipment waste 2b. As seen in FIG. 2, the metal powder 14 can be referred to as a fine batteries powder 14 b when the electronic waste to be treated consists of the unsorted spent batteries. As seen in FIG. 3, the metal powder 14 can be referred to as an electronics powder 14c when the electronic waste to be treated consists of the electronic equipment waste.

In some implementations, the electronic waste comprises unsorted spent batteries and the process can further comprise inerting the spent batteries prior to fragmenting the electronic waste. In implementations where the electronic waste 2 includes spent batteries 2a, as seen in FIG. 1, the inerting 16 of the spent batteries 2a can be performed before fragmenting 4 the electronic waste 2 to reduce the risk of explosion and fire during fragmenting 4. This risk is mainly associated with the presence of lithium batteries and Ni-MH batteries in the spent batteries.

For example, the mixture of spent batteries can undergo the inerting step by freezing the spent batteries, for example using liquid nitrogen, which are then left to thaw quietly. In another example, the inerting can include discharging the spent batteries by soaking them for a few hours in an aqueous saline or acidic solution. The aqueous saline or acidic solution can be reused for several battery inerting steps. In yet another example, the inerting and the fragmenting can be performed simultaneously by fragmenting the spent batteries under a non-oxidizing environment, such as, for example, a nitrogen atmosphere.

The fragmenting of the electronic waste into the fragmented waste can be performed according to various techniques available in the field. The fragmenting is performed to reduce a size of the electronic waste and produce fragments of various sizes.

The fragments can be produced by at least one of crushing, shredding, cutting, and grinding. Referring to FIG. 1, the electronic equipment waste 2b does not require an inerting step and can be combined with the inerted batteries 2c for further fragmenting 4 by crushing and shredding to produce the fragmented waste 6. The fragmented waste 6 comprises the coarse fraction 12 and the fine fraction 10. The fine fraction 10 includes the metal powder 14 and other components including plastic, paper, and a metal fraction comprising a ferrous metal powder.

Still referring to FIG. 1, the fragmenting step 4 is followed by the recovery of the metal powder 14 in multiple steps. Depending on the nature of the fragmented waste 6, the recovery can include separating 8 the fine fraction 10 from the fragmented waste 6, removing undesired fractions from the fine fraction 10, until recuperating the metal powder 14. The recovery can include separating 8 the fragmented waste 6 into the coarse fraction 12 and the fine fraction 10. The separation 8 can be performed according to various techniques available in the field to recover a fine fraction having an average particle diameter inferior of 1 mm. For example, the separation 8 can include sieving. A sieve with openings of less than 5 mm, and preferably of 1 to 2 mm, can be used for this step of separation 8. The coarse fraction 12 can be recycled back to the fragmenting step 4 to obtain a suitable particle size.

In some implementations, as shown in FIG. 1, the recovery of the metal powder 14 can further include subjecting the fine fraction 10 to an attrition step 18 with water 20 to remove and separate debris that are stuck to the surfaces of the particles of the fine fraction 10 and/or to break up agglomerates of particles of the fine fraction 10. The attrition step 18 can be performed by preparing a solution of the fine fraction 10 and water 20 with a solids content varying between 30% and 70% to form a fine fraction solution. This fine fraction solution can then be stirred vigorously in a stirred tank-type reactor for a period of 2 to 15 min.

Still referring to FIG. 1, once attrition is completed, the fine fraction solution 22 can be subjected to a gravimetric separation 24 such as a flotation separation step to separate the fine fraction solution 22 into a low-density material 26 and a resulting metal fraction 28. The gravimetric separation 24 can be derived from any gravitational-based method and can simply include letting the solution 22 from the attrition step 18 settle and separating the floating low-density material 26 which can include particles of plastic, paper, and cardboard remaining on top of the solution 22. Optionally, the separation of the low-density material 26 can be further facilitated by injecting air into the fine fraction solution 22.

Still referring to FIG. 1, the recovery of the metal powder 14 can further include a magnetic separation 30 to separate the metal fraction 28 into a ferrous metal powder 32 (including scraps of ferrous metal, such as iron scraps) and the metal powder comprised in a non-magnetic metal fraction 34. It should be noted that, when attrition is used, the metal fraction 34 is provided in a solution including non-ferrous metals. Thus, the metal powder 14 can be further recovered via a solid-liquid separation 36, such as filtration, centrifugation or settling. Optionally, the water 38 used for the attrition, gravitational-based method and magnetic separation stages can be recovered. Such used water 38 can contain dissolved solids 42 which can be partially removed by a wastewater treatment 40 comprising precipitation and the treated water 44 can be reused for other treatment loops.

In another embodiment, the spent batteries and the electronic equipment waste can be treated separately to recover the metal powder.

### Leaching of the Basic Metals and the REEs

The process for treating the electronic waste further comprises leaching the REEs and the basic metals from the metal powder to produce a residual metal-depleted solid and at least one of a REE-enriched leachate and a basic metal-enriched leachate.

When the electronic waste comprises electronic equipment waste, the precious metals are further leached from the residual metal-depleted solid. In an embodiment where the electronic waste comprises or consists of the spent batteries, the leaching of the REEs and the leaching of the basic metals from the metal powder can be performed simultaneously. In an embodiment where the electronic waste comprises or consists of the electronic equipment waste, the leaching of the REEs, the leaching of the basic metals, and the leaching of the precious metals can be performed selectively, and more particularly successively.

Leaching refers to the use of a leaching solution to solubilize the metals comprised in the solid particles of the metal powder derived from the electronic waste encompassed herein. In some implementations, the leaching solution for the solubilization of REEs can be the same as the leaching solution for the solubilization of the basic metals, thereby forming a leachate comprising solubilized REEs and basic metals. The leaching solution for solubilizing REEs and/or basic metals can be a diluted sulfuric acid solution.

The leaching solution for solubilizing precious metals included in the metal powder can be a diluted thiourea solution. Acid leaching refers herein to the use of an inorganic acid as at least a portion of the acid leaching solution. When referring to multiple acid leaching steps to perform the leaching of the REEs and the basic metals, the nature of the inorganic acid, the composition and concentration of the acid leaching solution may vary from one acid leaching step to the other.

In some implementations, the leaching of the metals (REEs, basic metals, and/or precious metals) or the washing of the residual solids can be performed using a counter-current process. For example, the metals of the electronic waste (or residual solid derived from a prior leaching/washing/extraction step) can be leached by contacting a leaching solution flowing counter-currently to the metal powder. Unless indicated otherwise, leaching can further encompass washing the residual solid with water subsequently to contacting the residual solid with the leaching solution.

In an embodiment, the leaching of basic metals and REEs from the metal powder can comprise simultaneously leaching the REEs and the basic metals by contacting the metal powder (e.g., fine batteries powder) with a leaching solution to solubilize at least a portion of both the REEs and the basic metals. For example, referring to FIG. 2, the fine batteries powder 14b can be contacted with an acid solution 46 for the acid leaching 48 and produce a first solid-liquid mixture 50 comprising a REE-enriched leachate 52 and a metal-depleted residual solid 54.

The leaching 48 of the basic metals and REEs from the metal powder 14 can be carried out by mixing a given amount of metal powder 14 with an inorganic acid, such as sulfuric, hydrochloric, or nitric acid. For example, sulfuric acid can be used. The leaching solution 46 can have an acid concentration between 0.5 and 5.0 N. The leaching of basic metals and REEs can be performed with a ratio of a weight of the metal powder to a volume of the leaching solution is between 50 g/L and 200 g/L and can comprise mixing for a period of 15 to 120 min. Preferably, a sulfuric acid concentration of 4.0 N is used with a solids content of around 100 g/L and a reaction time of 30 min. The temperature can be maintained between 5 and 95° C. during the leaching of basic metals and REEs, with a recommended temperature of 20° C.

In some implementations, the leaching solution for leaching the basic metals and REEs from the metal powder further comprises hydrogen peroxide, sodium metabisulfite, or a combination thereof, in addition to the inorganic acid.

After the contacting of the metal powder 14 with the leaching solution 46, still referring to FIG. 2, the first solid-liquid mixture 50 can be separated into the metal-depleted residual solid 54 and the REE-enriched leachate 52, wherein the REE-enriched leachate 52 comprises both the REEs and the basic metals by a solid-liquid separation 56. The solid-liquid separation 56 described herein can be performed according to known techniques in the field, such as, for example, filtration, centrifugation and/or settling. The metal-depleted residual solid 54 can be an MnO₂ concentrate.

In some implementations, still referring to FIG. 2, the metal-depleted residual solid 54 can undergo an additional rinsing 58, for example with water 60, and a further solid-liquid separation 62 to recover a cleaner metal-depleted residual solid 64 (e.g., MnO₂ concentrate). The washing effluent that is produced as the liquid fraction 66 can be recycled to the acid leaching 48.

It should be noted that the metal-depleted residual solid can include a remainder of REEs and/or basic metals, and thus the leaching can include multiple successive leaching and/or washing steps to maximize the amount of REEs and basic metals that is solubilized in the REE-enriched leachate. For example, the metal-depleted residual solid can undergo further successive leaching steps (e.g., between 0 and 4 additional steps) with acid and/or be rinsed by one or more mixing steps with water. The volume of solution generated can be reduced using the principle of counter-current washing and leaching steps. Optionally, the process can include washing the metal powder in water before acid leaching to remove a significant proportion of the potassium and sodium present in the metal powder.

In another embodiment, more particularly when the electronic waste comprises electronic equipment waste, it is possible to carry out the leaching of REEs, basic metals and precious metals by selective leaching steps. For example, selectively leaching the REEs and the basic metals can comprise leaching the REEs prior to leaching the basic metals. Referring to FIG. 3 for which the metal powder 14 is an electronics powder 14c, the teaching of the REEs can comprise contacting the metal powder 14 with a first leaching solution 68, for example an acid solution, to perform a first leaching 70 and solubilize at least a portion of the REEs, thereby producing a first solid-liquid mixture 72 comprising a REE-enriched leachate 74 and a REE-depleted residual solid 76. The REE-enriched leachate 74 comprises the at least a portion of the REEs from the metal powder. Then, the REE-enriched leachate 74 and the REE-depleted residual solid 76 can be separated by a first solid-liquid separation 78.

The first leaching solution 68 can comprise an inorganic acid solution (having an acid concentration between 0.2 and 1.0 N). The leaching of the REEs can be performed using a ratio of a weight of the metal powder to a volume of the first leaching solution between 50 g/L and 200 g/L. The leaching of the REEs can also comprise a mixing step lasting 15 to 120 min. Preferably, a sulfuric acid concentration of 0.4 N is used with a solids content of around 100 g/L and a reaction time of 30 min. The temperature of the mixture can be maintained between 5 and 95° C. during the leaching of the REEs, with a recommended temperature of 20° C. After the leaching of the REEs, the REE depleted residual solid and the REE enriched leachate can be separated by the solid-liquid separation.

Still referring to FIG. 3, the second step of selectively leaching the REEs and the basic metals, which can consist of leaching of the basic metals 80, can include contacting the REE-depleted residual solid 76 with a second leaching solution 82 to solubilize at least a portion of the basic metals and to produce a second solid-liquid mixture 84 comprising the basic metal-enriched leachate 86 and the metal-depleted residual solid 88. The basic metal-enriched leachate 86 and the metal-depleted residual solid 88 can then be separated by another and second solid-liquid separation 90.

In some implementations, the second leaching solution 82 can comprise an inorganic acid solution and an oxidizing agent. The oxidizing agent can be hydrogen peroxide. The inorganic acid solution can be a solution of sulfuric, hydrochloric, or nitric acid. The leaching of the basic metals can require an acid concentration of the second leaching solution between 1.0 N and 5.0 N and weight ratio of the oxidizing agent to the REE-depleted residual solid between 0.33 and 1.33.

For example, assuming the basic metal content is equivalent to the copper content, the amount of oxidizing agent to add can be determined on a stoichiometric basis by knowing a basic metal content present in the powder mixture as follows:

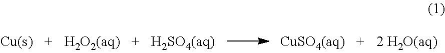

The oxidizing agent amount of oxidizing agent to add to the second leaching solution can be stoichiometrically sufficient to oxidize the basic metals present in metallic form in the metal powder, more precisely in the REE-depleted residual solid.

In some implementations, a ratio of a weight of the REE-depleted residual solid to a volume of the second leaching solution is between 50 g/L and 200 g/L can be used for the leaching of the basic metals and a mixing period of 60 to 360 min. Preferably, a sulfuric acid with an acid concentration of 2.0 N and 0.67 g H₂O₂/g of REE-depleted residual solid can be used with a solids content of around 100 g/L and a reaction time of 180 min. The temperature during the leaching of the basic metals can be maintained between 5 and 95° C., with a recommended temperature of 80° C. After the leaching of the basic metals, the metal depleted residual solid, and the basic metal enriched leachate can be separated by a solid-liquid separation.

In some embodiments, the leaching of the REEs and the basic metals from the metal powder can comprise performing multiple successive acid leaching steps of the REEs and the basic metals. In other embodiments, the leaching of the REEs and the basic metals from the metal powder can comprise performing at least one acid leaching of the REEs and basic metals and at least one washing of the metal-depleted residual solid with water.

In some embodiments, the metal powder can comprise precious metals. Therefore, a third leaching step can consist of leaching the precious metals from the metal-depleted residual solid to produce a precious metal-enriched leachate and a metal concentrate. Still referring to FIG. 3 for example, leaching the precious metals 92 can comprise contacting the metal-depleted residual solid 88 with a third leaching solution 94 to solubilize at least a portion of the precious metals and to produce a third solid-liquid mixture 96 comprising the precious metal-enriched leachate 98 and the metal concentrate 100.

The third leaching solution can include or consist of a thiourea solution, a thiosulfate solution, a cyanide solution, or any mixtures thereof. Leaching the precious metals can be accomplished by forming soluble complexes with the thiourea solution, thiosulfate solution or cyanide solution. The use of the thiourea solution can be recommended for the extraction of precious metals since the extraction can be carried out in an acidic environment, which can avoid a significant increase in pH.

In some implementations, the third leaching solution can further comprise an oxidant in an amount stoichiometrically sufficient to oxidize the precious metals in metallic form.

Thiourea can also be used for metal leaching due to its low toxicity (LD50 (thiourea)=125 mg/kg and LD50 (Potassium cyanide)=5 mg/kg), promising recovery rates, faster kinetics, and high selectivity.

The precious metal can comprise gold (Au), silver (Ag) and platinum group metals (PGMs) or any combinations thereof.

Leaching of the precious metals can be done according to the following equations with iron as oxidant:

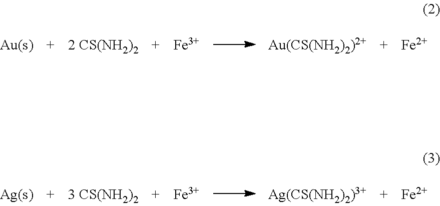

The precious metal leaching can also be done in the presence of cyanide according to the following equations:

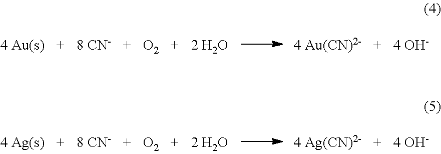

It can also be possible to solubilize platinum group metals (PGMs) with sodium cyanide. Indeed, under pressure, soluble complexes are formed according to the following equations:

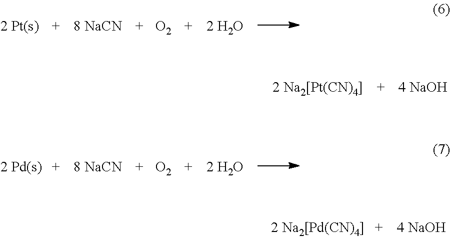

According to the equation below, gold can also be dissolved by complexation with thiosulfate solutions in the presence of copper and ammonia ions:

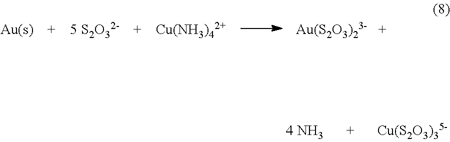

In some implementations, the leaching of the precious metals can be carried out using the third leaching solution comprising an inorganic acid, such as sulfuric acid, a thiourea solution (leaching agent concentration between 0.10 and 0.50 of leaching agent per gram of the metal-depleted residual solid.) and a ferric iron salt (between 0.00 and 0.10 of oxidant per gram of the metal-depleted residual solid). The third leaching solution can have an acid concentration between 0.1 and 0.5 N. The leaching of precious metals can be performed according to a solids content between 50 and 200 grams of the metal-depleted residual solid per liter of the third leaching solution.

For example, an acid concentration of 0.2 N with a thiourea concentration of 0.25 g/g and 0.06 g Fe³⁺/g of the metal-depleted residual solid can be used with a solids content of around 130 g/L and a reaction time of 120 min. The temperature can be maintained between 5 and 95° C. during the leaching of the precious metals, with a recommended temperature of 20° C.

Referring to FIG. 3, the process further includes another and third solid-liquid separation 102 to separate the third solid-liquid mixture 96 into the precious metal-enriched leachate 98 and the metal concentrate 100.

Selective Extraction of the REEs, Basic Metals and Precious Metals (when Present)

### Recovery of MnO₂

The metal-depleted residual solid resulting from the simultaneous leaching stages of the REEs and basic metals from the metal powder can consist mainly of a concentrate of manganese oxide (MnO₂) (≥85% purity) which can be re-used in industry. This final solid can therefore be dried before being recycled in industry or sold as a concentrated source of manganese.

### Recovery of REEs

The REE-enriched leachate can be further treated to extract and isolate an extracted REE-containing component.

In one embodiment, the extracting of the REEs can first comprise precipitating REE-hydroxides and/or REE-sulfates by adding a base solution to the REE-enriched leachate to produce a fourth solid-liquid mixture comprising the REE-containing component and a secondary leachate, wherein the REE-containing component comprises the REE-hydroxides and/or REE-sulfates. Then, the REE-containing component and the secondary leachate can be separated by solid-liquid separation.

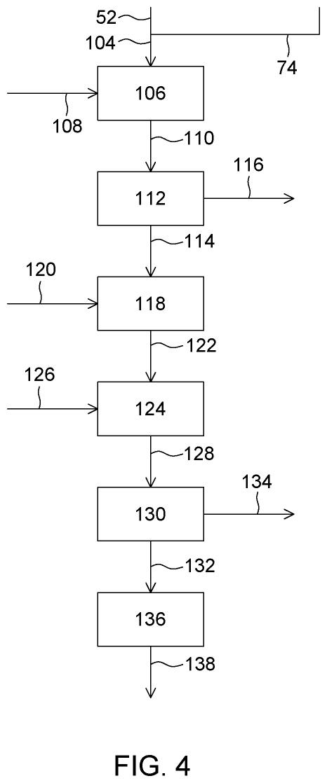

In another embodiment, referring to FIG. 4, the extracting of the REEs can comprise precipitating 106 REE-hydroxides and/or REE-sulfates by adding a base solution 108 to the metal-enriched leachate 104 to produce a fourth solid-liquid mixture 110, separating 112 the REE-hydroxides and/or the REE-sulfates 114 from the fourth solid-liquid mixture 110 via solid-liquid separation 112, re-dissolving the REE-hydroxides and/or the REE-sulfates 114 in an acid solution 120 to form an REE-containing solution 122 and precipitating 124 REE-oxalates by adding an oxalic acid and/or an oxalate salt 126 to the REE-containing solution 122 to produce a fifth solid-liquid mixture 128 comprising the REE-oxalates. The REE-oxalates can then be separated 130 from the fifth solid-liquid mixture 128 as the REE-containing component 132.

In still another embodiment, the extracting of the REEs comprises precipitating REE-oxalates by adding a sulfate salt to the REE-enriched leachate to produce a secondary solid-liquid mixture comprising the REE-oxalates and the secondary leachate; and separating the REE-oxalates and the secondary leachate from the fourth solid-liquid mixture via solid-liquid separation as the REE-containing component.

Precipitating the REE-hydroxides and/or REE-sulfates can occur when the pH is increased to values greater than 1.2. The pH can be increased to 1.5 by adding a base solution, such as sodium hydroxide. Potassium hydroxide (KOH), calcium hydroxide (Ca(OH)₂) and magnesium hydroxide (Mg(OH)₂) can also be used as base solutions. The fourth solid-liquid mixture can be mixed for a period of 5 to 60 min, and preferably during a period of 10 min. The temperature of the fourth solid-liquid mixture can be maintained between 5 and 95° C. during the precipitation step, with a recommended temperature of 20° C.

Precipitating REE-hydroxides and/or REE-sulfates can be favored when using sulfuric acid as the acid solution. Precipitating REE-oxalates can also be helped by adding a sulfate salt, such as sodium sulfate or potassium sulfate or any mixture thereof.

The fifth solid-liquid mixture (or secondary solid-liquid mixture) can be mixed for a period of 5 to 60 min, and preferably during a period of 10 min. The temperature of the fifth solid-liquid mixture (or secondary solid-liquid mixture) can be maintained between 5 and 95° C. during the precipitating of the REE-oxalates, with a recommended temperature of 20° C. The pH of the fifth solid-liquid mixture (or secondary solid-liquid mixture) is maintained between values of 0.70 to 0.80, and preferably at pH of about 0.75. The REE-oxalates can be recovered by a solid-liquid separation. The purity of the REE-oxides concentrate obtained can be >90%.

Still referring to FIG. 4, the REE-containing component 132 can also be converted to REE oxides (concentrate) 138 by calcination 136. Optionally, the calcination 136 can be performed at a calcination temperature between 700° C. and 800° C. for a duration between 2 and 4 hours.

The REE-sulfates 114, REE-oxalates 132, and/or REE-oxides 138 generated during these steps can be used in industry or sold as a concentrated source of rare earth elements.

It should be noted that the present process allows combining streams produced by different sequences of steps. For example, the metal and REE-enriched leachate 52 produced by the simultaneous leaching of basic metals and REEs as shown in FIG. 2 can be combined with the REE-enriched leachate 74 produced by the selective leaching of the REEs as shown in FIG. 3 to form the leachate 104 that is shown in FIG. 4, thereby optimizing the efficiency of the overall process.

### Recovery of Basic Metals

The process further includes selectively extracting the basic metals from at least one of the basic metal-enriched leachate and the secondary leachate to produce multiple extracted components, each extracted component comprising at least one of the basic metals. It should be noted that, upon extracting the REEs from the REE-enriched leachate, the secondary leachate is produced. Such secondary leachate can comprise basic metals when the REE-enriched leachate is produced by the simultaneously leaching of the REEs and basic metals. Alternatively, the basic metals can rather be contained in the basic metal-enriched leachate when the leaching of the REEs and basic metals is selective, i.e., when the electronic waste comprises electronic equipment waste.

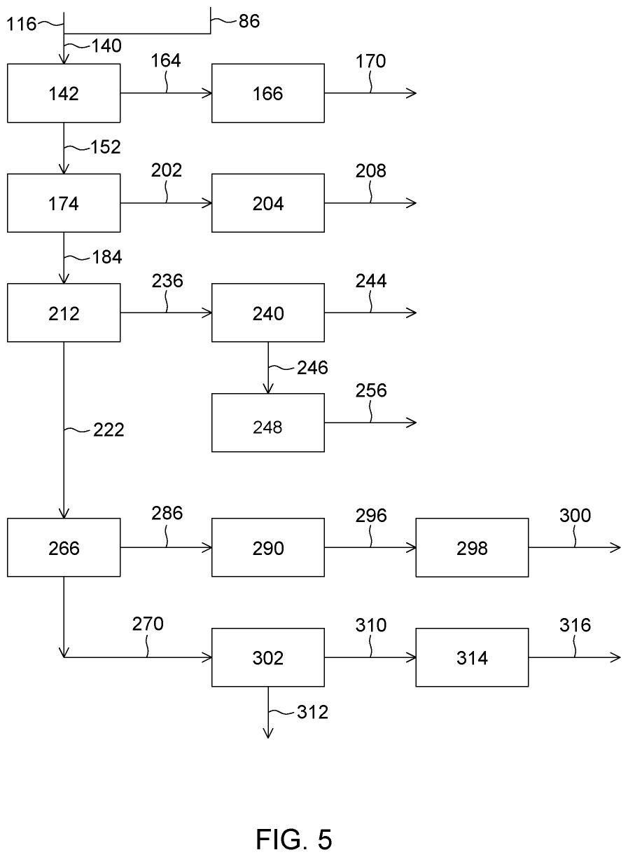

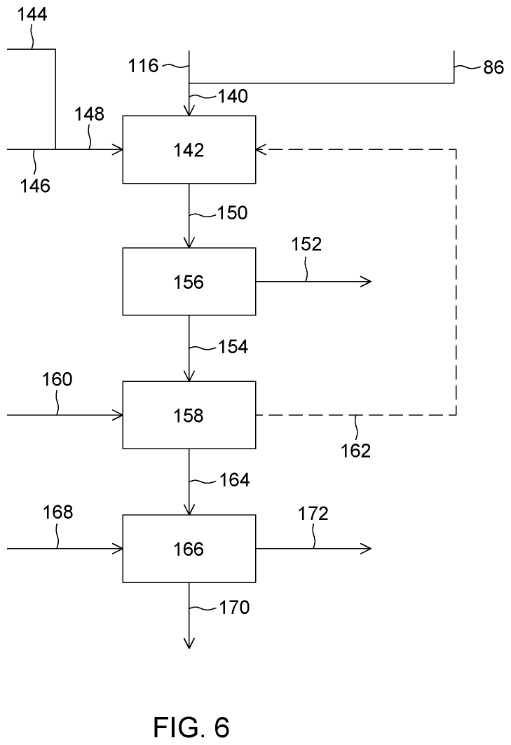

In some embodiments, as seen in FIGS. 5 and 6, the process can comprise mixing the basic metal-enriched leachate 86 and the secondary leachate 116 to form a metal-enriched leachate 140. The selective extracting of the basic metals can then be performed from the metal-enriched leachate 140.

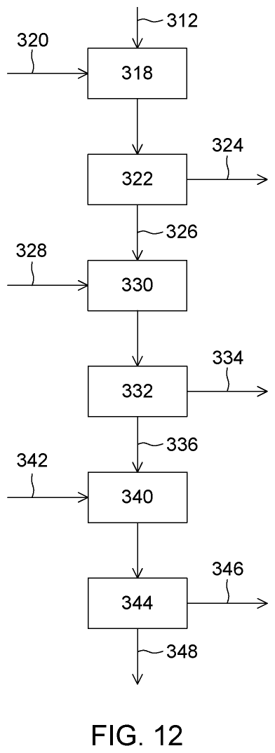

Referring to FIGS. 5 and 12, the basic metals can comprise copper, zinc, cadmium, manganese, cobalt, nickel and lithium, and the multiple extracted components successively produced by the selective extracting of the copper, zinc, cadmium, manganese, cobalt, nickel and lithium comprise metallic copper (Cu), metallic zinc (Zn), metallic cadmium (Cd), a manganese carbonate concentrate (MnCO₃), a cobalt oxide concentrate (CoO), a nickel oxide concentrate (NiO), lithium carbonate (LiCO₃) and lithium phosphate (Li₃PO₄).

It should be noted that selectively extracting the basic metals can comprise successively extracting each one of the basic metals to produce each extracted component comprising one basic metal. Details for example extraction of each basic metals are further provided.

### Recovery of Copper

As used herein, the abbreviation “S/L ratio” means solid/liquid ratio. As used herein, the abbreviation “O/A ratio” means organic to aqueous ratio.

Referring to FIGS. 5 and 6, a first solvent extraction step 142 can consist of the separation of copper. The leachate 140 is first adjusted at pH of about 2.0 by adding a base 144, preferably sodium hydroxide. The leachate 140 is also brought into contact with an organic solvent 146 that can consist, for example, of approximately 45% (v/v) Mixed aldoxime-ketoxime reagent (e.g., LIX 84-I), and 55% (v/v) kerosene. Two stages of organic solvent extraction 142 with an Organic phase 154/Aqueous phase 152 (O/A) ratio of 1:1 (v/v) are usually required to completely extract the copper from the aqueous phase 152. The temperature of the extraction step is kept at a temperature of about 20 to 60° C., and preferably to about 20° C. The organic phase and aqueous phase are separated by S/L separation 156. The copper is then selectively stripped 158 from the organic phase 154 by the addition of a solution 160 of H₂SO₄ (2 N) at an O/A ratio of 1:1 (v/v). Most of the copper present in the organic phase 154 is stripped in the first step. The stripped solution 162 obtained from the stripping step 158 is recycled to the next cycle. The extraction 142 and the stripping 158 retention times are fixed to approximately 10 min for all the steps. The copper present in the first stripping solution 164 is then electrodeposited 166 at about pH of 2.0. During electrodeposition 166, the pH of the solution is kept constant by the addition of a base 168, like sodium hydroxide. The temperature of the electrodeposition step 166 is kept at a temperature of about 20 to 40° C., and preferably to about 20° C. Metallic copper 170 having a purity of at least 98% can be recovered. An effluent 172 is produced as a byproduct of electrodeposition, which can be recycled.

Stainless steel or copper can be used as cathode material, whereas Ti/IrO₂ can be used as anode material. A current density fixed at about 300 A/m² with a retention time of approximately 60 minutes makes it possible to obtain a high yield of removal of the copper which is deposited at the cathode in the form of metallic copper.

### Recovery of Zinc

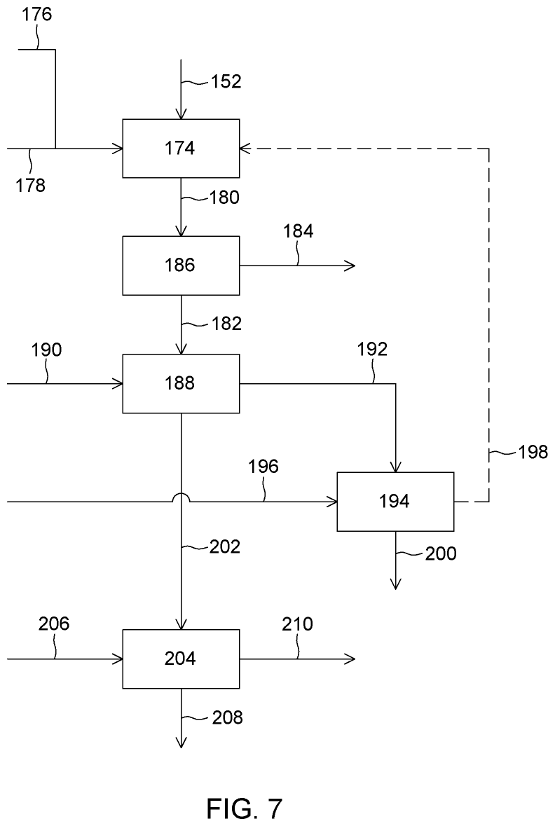

Referring to FIG. 7, the Cu-depleted solution 152 obtained after the Cu removal can then be treated by solvent extraction 174 to concentrate the zinc. The leachate 152 is first adjusted to pH close to 2.0 to 2.5 by adding a base 176, preferably sodium hydroxide.

The leachate 170 is also brought into contact with an organic solvent 178 consisting of approximately 20-30% (v/v) bis/2,4,4-trimethylpentyl/phosphinic acid (Cyanex 272), 2% (v/v) tri-butyl phosphate (TBP) and 68-78% (v/v) kerosene. Two stages of organic solvent extraction 174 with an Organic phase 182/Aqueous phase 184 (O/A) ratio of 2:1 (v/v) are usually required to completely extract the zinc from the aqueous solution. The temperature of the extraction step 174 is kept at a temperature of about 40 to 60° C., and preferably to about 50° C. The organic phase 182 and aqueous phase 184 are separated by S/L separation 186. The zinc is selectively stripped 188 from the organic phase 182 by the addition of a solution 190 of H₂SO₄ (0.2 N) at an O/A ratio of 2:1 (v/v). Most of the zinc present in the organic phase 182 is stripped in a single step 188. The residual iron 200 present in the second organic phase 192 can be stripped 194 by the addition of a more concentrated solution 196 of H₂SO₄ (e.g., 2.0 N) with an O/A ratio of 2:1 (v/v). The stripped solution 198 obtained from the second stripping step 194 is recycled to the next cycle. The extraction and the stripping retention times are fixed to approximately 10 min for all the steps.

The zinc present in the first stripping solution 202 is then electrodeposited 204 at about pH of 2.0. During electrodeposition 204, the pH of the solution is kept constant by the addition of a base 206, such as sodium hydroxide. The temperature of the electrodeposition step 204 is kept at a temperature of about 40 to 60° C., and preferably to about 50° C. Stainless steel or aluminum can be used as cathode material, whereas Ti/IrO₂ or Pb/Ag can be used as anode material. A current density can be fixed at about 250 to 750 A/m² with a retention time of approximately 2 to 3 h to obtain a high yield of removal of the zinc which is deposited at the cathode in the form of metallic zinc 208. The purity of the metallic zinc 208 is usually of at least 98%. Another effluent 210 is produced as a byproduct of electrodeposition, which can be recycled.

### Recovery of Cadmium

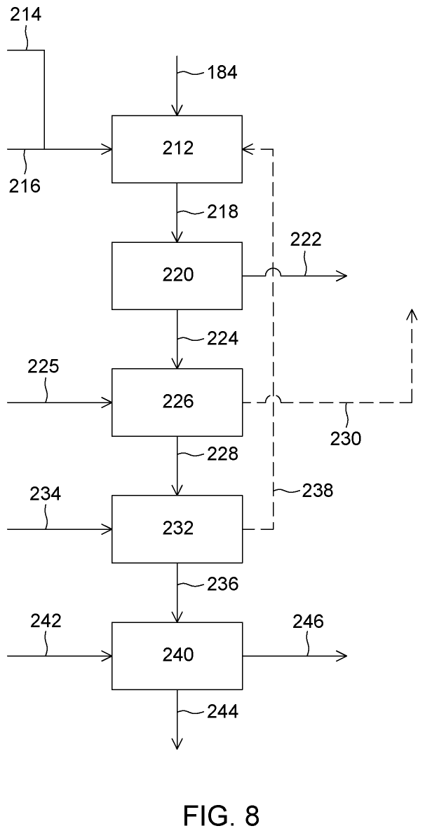

Referring to FIG. 8, the step following extraction of zinc is the recovery of cadmium from the Zn-depleted aqueous solution 184. The pH of this solution 184 is firstly adjusted at about pH of 2.7 to 2.9 by adding a base 214 before being mixed with the organic solvent 216. The organic solvent 216 can comprise, for example, approximately 30% of (v/v) Di-(2-ethylhexyl) phosphoric acid (D2EHPA), 5% (v/v) of TBP and 65% (v/v) of kerosene. Two stages of organic solvent extraction 212 with an O/A ratio of 2:1 (v/v) are usually required to completely extract the cadmium from the aqueous solution. The temperature of the extraction step 212 is kept at a temperature of about 40 to 60° C., and preferably to about 50° C. The equilibrium pH is adjusted between 2.2 and 2.9 during extraction. Cd and Mn are co-extracted and transferred to the organic phase 224 of the extracted solution 218. Separation 220 of the organic phase 224 and the aqueous phase 222 can be performed, with the aqueous phase 222 being referred to as a Cu, Zn-, Cd-, Mn-depleted solution 222. After separation 220, the organic phase 224 can undergo a first scrubbing phase 226 that is used to eliminate the main impurities such as Ni and Co from the organic phase 224 with an acid solution 225, thereby forming a purified organic phase 228. The additional stripped solution 230 can form part of the Cu, Zn-, Cd-, Mn-depleted solution 222. The scrubbing 226 O/A ratio can be equal to 20:1 (v/v) and its initial pH is fixed at about 2.3. The Cd and Mn present in the purified organic phase 228 can then be further stripped by the addition of a solution 234 of H₂SO₄ 0.5 to 0.6 N with an O/A of 4:1 (v/v). The reaction time of the extraction steps (212, 226, 232) including the scrubbing step 226 and the stripping step 232 are fixed at 10 min for all these steps.

The stripped aqueous solution 236 can then be transferred to the electrolysis compartments. Here, the Cd was selectively electrodeposited 240 from the aqueous solution 236 while the other metals (Mn and traces of Ni, Co, Zn) remained in the aqueous solution. The selective electrodeposition/electrowinning 240 of Cd was conducted at about pH of 2.0 with a current density fixed at about 360 to 370 A/m², and a retention time of approximately 2 to 4 h. The temperature of the electrodeposition step 240 is kept at a temperature of about 40 to 60° C., and preferably to about 50° C. During electrodeposition, the pH of the solution 236 is kept constant by the addition of a base 242, like sodium hydroxide. Stainless steel can be used as cathode material, whereas Ti/IrO₂ can be used as anode material. The purity of the metallic cadmium 244 being deposited at the cathode can be of at least 98%. A manganese-rich solution 246 can be also recovered.

In other implementations, cadmium can be recovered by precipitation in the form of cadmium sulfide (CdS) instead of an electrodeposition step. This CdS precipitation takes place after raising the pH to around 4.0 by adding a base and by adding a sulfide salt, such as Na₂S or NaHS to the stripped aqueous solution 236. A solid/liquid separation step is then used to separate the CdS precipitate from the manganese-rich solution.

### Recovery of Manganese

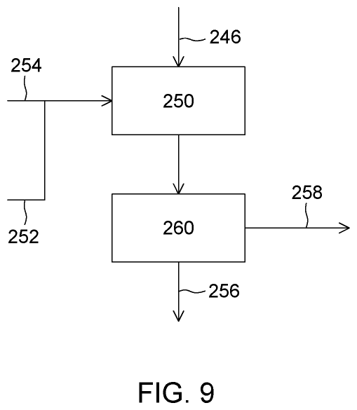

After the cadmium electrodeposition, the remaining MnSO₄ solution 246 is transferred to a precipitation step 250 as presented in FIG. 9. The solution is adjusted at pH of about 7.0 by the addition of a base 252 (e.g., NaOH or KOH solution) followed by the addition of a carbonate salt 254 (e.g., Na₂CO₃ or K₂CO₃). The manganese present in the MnSO₄ aqueous solution 246 is precipitated at pH of about 8 to 9. The solution is mixed for a period of 15 to 240 min. The resulting MnCO₃ precipitates 256 are then recovered by a solid-liquid separation 260, with another effluent 258 to be recycled being also recovered separately. The solids 256 can also be washed with water to remove impurities before dewatering and drying (not shown in FIG. 9). The final product can be recycled in industry or sold as a concentrated source of manganese. The purity of the MnCO₃ 256 obtained can be of at least 94%.

### Recovery of Cobalt

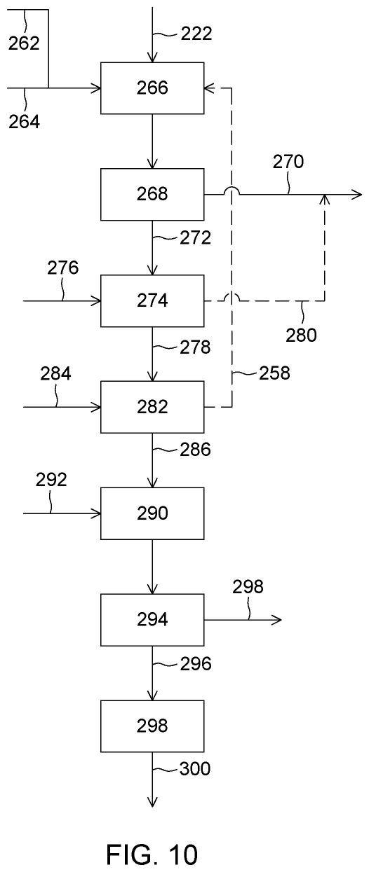

Referring to FIG. 10, the next step of the chain consists in the recovery of cobalt from the Zn-, Cd-, and Mn-depleted solution 222. The pH of this solution 222 is firstly adjusted at about pH of 5.2 to 5.5 by adding a base 262 before being mixed with the organic solvent 264. The organic solvent 264 comprises approximately 10% (v/v) of Bis/2,4,4-trimethylpentyl/phosphinic acid (Cyanex 272), 2% (v/v) of TBP and 88% (v/v) of kerosene. One stage of organic solvent extraction 266 with an O/A ratio of 1:2 (v/v) is usually required to completely extract the Co and Ni from the aqueous phase 270. The temperature of the extraction step 266 is kept at a temperature of about 40 to 60° C., and preferably to about 50° C. Co and Ni are co-extracted and transferred to the organic phase 272. Separation 268 of the organic phase 272 and the aqueous phase 270 is further performed, with the aqueous phase 270 being referred to as a Cu, Zn-, Cd-, Mn-, Co-depleted solution 270. After separation 268, the organic phase 272 can undergo a first scrubbing 274 that is carried out by adding a scrubbing agent 276, such as CoSO₄, to eliminate the Ni from the organic phase 272 and form a depleted organic phase 278. The secondary aqueous phase 280 recovered from the scrubbing 274 can be used as part of the Cu, Zn-, Cd-, Mn-, Co-depleted solution 270. The scrubbing 274 O/A ratio was equal to 4:1 (v/v). The Co present in the organic phase 278 can then be stripped 282 by the addition of a solution 284 of H₂SO₄ 0.25 N with an O/A of 2:1 (v/v). The reaction time of the extraction steps (266, 274, 282) including the scrubbing step 274 and the stripping step 282 are fixed at 10 min for all these steps.

The Co present in the resulting CoSO₄ solution 286 is then removed by precipitation 290 of Co oxalate. This is accomplished by the addition of a precipitation agent 292 being an oxalate salt or oxalic acid. The resulting Co oxalate precipitates 296 and additional effluent to recycle 298 are then recovered by solid-liquid separation 294.

The Co oxalate precipitates 296 can be further converted to Co oxides 300 by calcination 298. The CoO concentrate 300 generated following these steps can be used in industry or sold as a concentrated source of cobalt. The purity of the CoO obtained can be of at least 90%.

### Recovery of Nickel

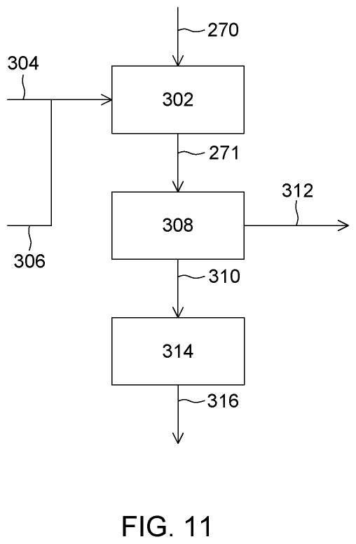

Referring to FIG. 11, the Ni present in the resulting Zn-, Cd-, Mn-, and Co-depleted solution 270 is then removed by precipitation 302 of Ni oxalate. This is accomplished by the addition of a precipitation agent 304 being an oxalate salt or oxalic acid. The pH can also be adjusted via addition of a base 306. The resulting solution is mixed for a period of 15 to 240 min. Ni oxalate precipitates 310 and a tertiary leachate 312 are then recovered by solid-liquid separation 308. The Ni oxalate precipitates 310 are then converted to Ni oxides (NiO concentrate) 316 by calcination 314. The NiO concentrate 316 recovered can be used in industry or sold as a concentrated source of nickel. The purity of the NiO obtained can be of at least 90%.

### Recovery of Lithium

Referring to FIG. 12, the lithium present in the aqueous fraction (tertiary leachate 312) at the end of the sequence of solvent extraction steps is recovered by selective precipitation in the form of lithium carbonate (Li₂CO₃) and lithium phosphate (Li₃PO₄).

Before carrying out the separation of the lithium, it is preferable to eliminate impurities by a step of precipitation 318 of the metals still present by formation of metal hydroxides at pH of about 7 to 10. The pH is adjusted by addition of a base solution 320 to the tertiary leachate 312, such as NaOH, KOH or Ca(OH)z. The precipitates 324 (metal hydroxide sludge) can be recovered by solid-liquid separation 322, thereby further recovering a lithium-containing solution 326 (e.g., lithium sulfate solution).

The resulting lithium-containing solution 326 is then treated by adding a carbonate salt or a concentrated solution of a carbonate salt 328, preferably sodium carbonate (Na₂CO₃) to trigger precipitation 330 of lithium carbonates. The quantity of carbonate 328 added must be sufficient to precipitate all the lithium according to the following reaction:

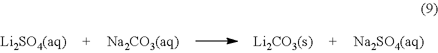

The temperature of the solution 326 is adjusted between 0 and 100° C., but preferably at a temperature of about 50° C. It should be noted that solubility of lithium carbonate decreases with an increase of temperature, i.e., 15.4 g/L (0° C.), 12.8 g/L (25° C.), 10.7 g/L (50° C.) and 7.2 g/L (100° C.). The solubility of sodium carbonate increases between 0 and 40° C., then remains almost constant up to 100° C., around 300 g/L. The pH of the solution 326 should preferably be maintained around 9.0-10.0. The solution is mixed for a period of 15 to 240 min. Sufficient mixing time must be maintained to obtain the formation of Li₂CO₃ crystals. The lithium carbonate 334 formed is then recovered by solid-liquid separation 332. This solid 334 can be washed with water to remove some of the impurities and then dried before being reused in industry or sold as a concentrated lithium source.

The lithium remaining in solution 336 (referred to as lithium-depleted solution 336) after the lithium carbonate precipitation step 330 can be recovered by precipitation of lithium phosphate 340 following the addition of a phosphate salt 342, preferably sodium phosphate (Na₃PO₄). The desired reaction is as follows:

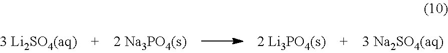

The solubility of Li₃PO₄ is lower than that of Li₂CO₃, with a value around 390 mg/L at alkaline pH.

Still referring to FIG. 12, the Li₃PO₄ precipitate 346 thus formed is recovered by an S/L separation technique 344. This solid 346 can also be washed and dried before being reused in industry or sold as concentrated lithium source. If the lithium concentration in the solution at the end of the solvent extraction steps is too low, it may be possible to proceed directly to a lithium phosphate precipitation step, without going through the lithium carbonate precipitation step.

### Recovery of Precious Metals

The process can further comprise extracting of the precious metals from the precious metal-enriched leachate to produce a precious metals concentrate and a recyclable effluent.

In some embodiments, the extracting of the precious metals from the precious metal-enriched leachate comprises using at least one of activated carbon adsorption, cementation, ion-exchange, or electrodeposition.

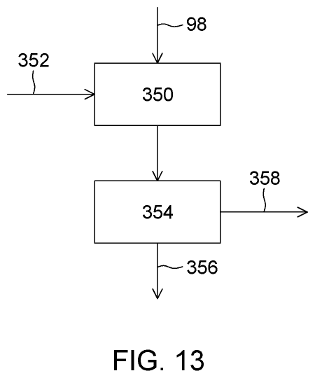

For example, referring to FIG. 13, the adsorption 350 of the precious metals contained in the precious metal-enriched leachate 98 can be performed on an activated carbon support 352 (e.g., activated coal). Upon further solid-liquid separation 354, a precious metals concentrate 356 and a final effluent to be recycled 358 can be recovered separately. Other conventional recovery techniques used in the mining industry can also be used to recover the precious metals concentrate.

It is noted that the final solid (metal concentrate) 100 obtained at the end of the leaching of the precious metals as shown in FIG. 3 consists mainly of a concentrate of Palladium (75% purity) which can be re-used in industry. This residue can therefore be dried before being recycled in industry or sold as a concentrated source of palladium.

### EXAMPLES

### Example 1—Leaching of Metals and REE from a Mixture of Spent Batteries

The collected spent batteries were frozen using nitrogen liquid and were then crushed to remove the steel castings. The fine particles were screened through a 1-2 mm aperture sieves, dried at 60° C. and then grinded. The fine particles were mixed during 45 min, at ambient temperature (20° C.) and at 80° C., with different sulfuric acid concentrations and a solids concentration of 100 g of powder per liter of acid solution. After treatment, the residual powder was separated from the solution by vacuum filtration. The percentage of metals and REE solubilized, which are presented in Tables 3 (20° C.) and 4 (80° C.), were established based on their concentrations measured in solution.

The results show an increase in the solubilization of metals and REE with increasing sulfuric acid content. High solubilization yields are obtained using 2.0 N or 4.0 N H₂SO₄. The solubilization yields obtained at elevated temperature are on the order of 10 to 20% higher than at room temperature for the metals and REEs of interest. Thus, more than 70% solubilization of all metals and REEs of economic interest (Cd, Co, Ce, La, Li, Mn, Nd, Ni, Y and Zn) in the context of battery recycling were obtained after a single leaching step at 80° C. in the presence of H₂SO₄ (2 N), except for manganese (40%) which is present largely in the form of manganese dioxide (MnO₂), which is practically insoluble in moderately acidic conditions.

It is to be noted that solubilization yields can be enhanced by applying more than one leaching step. The results show that it is also possible to remove much of the potassium and sodium ions by washing the spent batteries powder before the acid leaching step.

This washing can be done at room temperature as well as at elevated temperature (e.g., 80° C.).

TABLE 3
Metals and REE solubilization (%) form the batteries powder after
leaching at 20° C. with different sulfuric acid concentrations

| | | H₂SO₄ concentration (N) | | | | | Content |
|---|---|---|---|---|---|---|---|
| Elements | Water | 0.2 | 0.4 | 1.0 | 2.0 | 4.0 | (mg/kg) |
| Ca | 2.1 | 14.4 | 25.1 | 29.6 | 36.5 | 39.3 | 515 |
| Cd | 0.0 | 10.2 | 29.2 | 81.7 | 99.2 | 100 | 26443 |
| Ce | 0.0 | 0.0 | 0.7 | 26.3 | 53.5 | 75.2 | 2538 |
| Co | 0.0 | 1.6 | 5.9 | 28.9 | 51.3 | 64.2 | 13861 |
| Cu | 0.0 | 0.0 | 0.0 | 12.2 | 56.5 | 63.0 | 527 |
| Fe | 0.0 | 0.0 | 0.0 | 1.4 | 12.6 | 23.6 | 28190 |
| In | 0.0 | 0.6 | 1.7 | 14.5 | 34.8 | 47.4 | 3496 |
| K | 75.7 | 87.2 | 82.0 | 94.7 | 100 | 100 | 40258 |
| La | 0.0 | 0.0 | 4.1 | 30.0 | 55.4 | 76.3 | 9119 |
| Li | 5.2 | 9.0 | 11.9 | 38.7 | 60.4 | 75.3 | 1054 |
| Mg | 0.5 | 6.9 | 18.7 | 37.1 | 56.8 | 70.9 | 373 |
| Mn | 0.1 | 0.5 | 2.6 | 14.0 | 30.9 | 41.9 | 225973 |
| Na | 58.2 | 61.3 | 62.2 | 73.0 | 76.3 | 75.6 | 2763 |
| Nd | 0.0 | 0.0 | 2.8 | 26.8 | 53.9 | 81.4 | 3015 |
| Ni | 0.0 | 1.4 | 5.8 | 38.7 | 69.3 | 81.3 | 117963 |
| Pb | 0.0 | 0.7 | 13.1 | 4.7 | 17.7 | 27.1 | 205 |
| Y | 0.0 | 0.1 | 14.6 | 85.3 | 97.8 | 100 | 250 |
| Zn | 0.0 | 11.8 | 29.3 | 75.4 | 96.4 | 98.9 | 160841 |

Leaching time = 45 min, solids concentration = 100 g/L, One-leaching step.

TABLE 4
Metals and REE solubilization (%) form the batteries powder after
leaching at 80º C. with different sulfuric acid concentrations

| | | H₂SO₄ concentration (N) | | | | | Content |
|---|---|---|---|---|---|---|---|
| Elements | Water | 0.2 | 0.4 | 1.0 | 2.0 | 4.0 | (mg/kg) |
| Ca | 3.0 | 13.3 | 25.2 | 30.6 | 50.3 | 61.5 | 515 |
| Cd | 0.1 | 9.4 | 30.8 | 72.2 | 98.6 | 100 | 26443 |
| Ce | 0.0 | 0.0 | 1.0 | 16.9 | 70.8 | 93.2 | 2538 |
| Co | 0.0 | 1.3 | 5.8 | 25.5 | 69.5 | 92.9 | 13861 |
| Cu | 0.0 | 0.0 | 0.0 | 18.5 | 85.8 | 94.4 | 527 |
| Fe | 0.0 | 0.0 | 0.0 | 1.5 | 7.5 | 43.5 | 28190 |
| In | 0.0 | 0.0 | 1.9 | 10.7 | 43.4 | 68.3 | 3496 |
| K | 83.8 | 93.6 | 95.3 | 97.1 | 100 | 100 | 40258 |
| La | 0.0 | 1.1 | 5.0 | 23.1 | 80.3 | 96.6 | 9119 |
| Li | 5.9 | 10.2 | 16.0 | 37.9 | 78.0 | 97.2 | 1054 |
| Mg | 0.6 | 9.8 | 20.0 | 40.5 | 83.4 | 92.6 | 373 |
| Mn | 0.0 | 0.2 | 1.8 | 9.9 | 40.2 | 59.4 | 225973 |
| Na | 57.9 | 60.8 | 65.3 | 70.0 | 71.7 | 82.1 | 2763 |
| Nd | 0.0 | 0.8 | 3.4 | 17.9 | 86.5 | 100 | 3015 |
| Ni | 0.0 | 1.5 | 8.1 | 41.4 | 85.3 | 99.7 | 117963 |
| Pb | 0.0 | 16.3 | 17.7 | 22.6 | 97.4 | 99.8 | 205 |
| Y | 0.0 | 0.0 | 16.8 | 68.4 | 97.6 | 100 | 250 |
| Zn | 0.0 | 12.7 | 30.8 | 78.4 | 100 | 100 | 160841 |

Leaching time = 45 min, solids concentration = 100 g/L, One-leaching step.

### Example 2—Leaching of REE and Metals from a Smart-Phone Wastes

### Preparation of Electronics Powder

The collected samples are disassembled into their different components: plastics, printed circuit board assemblies, batteries and screens. The printed circuit board assemblies are then shredded, ground and sieved. After sieving, a powder with a particle size of inferior to 425 μm was obtained. After quartering, the electronics powder obtained is leached in acid solutions.

### Solubilization of REE and Metals

### Solubilization of REE

The powders of the samples are leached with solutions of strong inorganic acids (hydrochloric acid, nitric acid, sulfuric acid) with a preference for sulfuric acid (0.5-5N). Preferably, a sulfuric acid concentration of 0.4 N is used with a solids content of around 100 g/L and a reaction time of 30 min. The temperature of the mixture is maintained between 2° and 80° C. during the leaching step, with a recommended temperature of 20° C. After the leaching step, the residual solid and the acidic solution containing REE are separated by an S/L separation process, such as, for example, filtration, centrifugation or settling.

The fine particles were mixed during 45 min, at ambient temperature (20° C.) and at 80° C., with different sulfuric acid concentrations and a solids concentration of 100 g of powder per liter of acid solution. After treatment, the residual powder was separated from the solution by vacuum filtration. The percentage of REE solubilized, which are presented in Table 5, was established based on their concentrations measured in solution.

TABLE 5
REE solubilization (%) form the smart-phone
wastes after leaching at 20° C. with sulfuric acid

| | Acidic | Leaching | Leachate |
|---|---|---|---|
| | leachate | efficiency | residue |
| Elements | (mg/L) | (%) | (mg/kg) |
| Al | 75 ± 2 | 3.1 ± 0.3 | 22621 ± 1910 |
| Ba | 0.22 ± 0.19 | 0.01 ± 0.01 | 12552 ± 609 |
| Ca | 150 ± 5 | 7.4 ± 0.6 | 18841 ± 1121 |
| Co | 29.9 ± 0.8 | 58 ± 6 | 408 ± 56 |
| Cr | 5.2 ± 0.7 | 7 ± 1 | 554 ± 15 |
| Cu | 2.1 ± 0.4 | 0.006 ± 0.001 | 261443 ± 1505 |
| Dy | 39 ± 3 | 66 ± 5 | ND |
| Fe | 2759 ± 72 | 56 ± 5 | 14167 ± 551 |
| Ho | 2.0 ± 0.1 | 70 ± 2 | ND |
| In | 21 ± 2 | 87 ± 7 | ND |
| Mg | 20.5 ± 0.6 | 11 ± 2 | ND |
| Mn | 13.7 ± 0.1 | 30 ± 2 | ND |
| Na | 11.4 ± 0.5 | 0.87 ± 0.04 | 13152 ± 1070 |
| Nd | 891 ± 74 | 80 ± 7 | ND |
| Ni | 34 ± 4 | 1.5 ± 0.2 | 13478 ± 649 |
| Pr | 248 ± 19 | 82 ± 6 | ND |
| Si | 40 ± 3 | 5.2 ± 0.4 | ND |
| Sm | 31 ± 3 | 80 ± 7 | ND |
| Sn | 29 ± 10 | 0.3 ± 0.1 | 20312 ± 1188 |
| Ti | 8.1 ± 0.6 | 1.9 ± 0.1 | 3392 ± 169 |
| Y | 0.44 ± 0.03 | 16 ± 5 | ND |
| Zn | 227 ± 6 | 47 ± 4 | 2121 ± 99 |

Leaching time = 30 min, solids concentration = 100 g/L, One-leaching step.

### Solubilization of Copper

The residues from the leaching of rare earth elements are used for the leaching of base metals. For this purpose, it is used a diluted inorganic acid solution (between 2.0 N and 4.0 N) and a strong oxidant such as hydrogen peroxide (between 0.33 and 1.33 g H₂O₂/g of powder). The amount of oxidant to add can be determined on a stoichiometric basis by knowing the metal content (mainly copper) present in the powder mixture. The mixture of powder and acid solution having a solids content of between 100 and 150 g per liter of solution is mixed for a period of 30 to 180 min. Preferably, a sulfuric acid concentration of 2.0 N and 0.67 g H₂O₂/g of powder are used with a solids content of around 100 g/L and a reaction time of 180 min. The temperature of the mixture is maintained between 2° and 80° C. during the leaching step, with a recommended temperature of 80° C. After the leaching step, the residual solid and the acidic solution containing metals are separated by a standard S/L separation process. According to our experiments, 1 L of the leaching solution was composed of Cu (25.2 g) and Ni (1.4 g).

### Solubilization of Precious Metals

The solubilisation of the precious metals can be accomplished by forming soluble complexes with a thiourea, thiosulfate or cyanide solution. Therefore, precious metals leaching is carried out using a sulfuric acid (0.2N), thiourea solution (between 0.15 and 0.25 g/g) and a ferric iron salt (between 0.05 and 0.06 g Fe³+/g of powder). The mixture of powder and thiourea solution having a solids content of between 60 and 131 g per liter of solution is mixed for a period of 30 to 120 min. Preferably, a thiourea concentration of 0.25 g/g and 0.06 g Fe³⁺/g of powder are used with a solids content of around 131 g/L and a reaction time of 120 min. The temperature of the mixture is maintained between 18 and 25° C. during the leaching step, with a recommended temperature of 20° C. After the leaching step, the residual solid and the acidic solution containing precious metals are separated by a standard S/L separation process. According to our experiments, 1 L of the leaching solution was composed of Ag (5.7 g) and Ag (0.9 g).

1. A process for treating electronic waste comprising at least one of spent batteries and electronic equipment waste, the process comprising:
a) fragmenting the electronic waste to reduce a size thereof and produce a fragmented waste comprising a metal powder;
b) recovering the metal powder from the fragmented waste, wherein the metal powder comprises rare earth elements (REEs) and basic metals;
c) leaching the REEs and the basic metals from the metal powder to produce a residual metal-depleted solid and at least one of a REE-enriched leachate and a basic metal-enriched leachate; and
d) extracting the REEs from the REE-enriched leachate to produce a REE-containing component and a secondary leachate; and
e) selectively extracting the basic metals from at least one of the basic metal-enriched leachate and the secondary leachate to produce multiple extracted components, each extracted component comprising at least one of the basic metals.

2. The process of claim 1, wherein the basic metals comprise Cd, Co, Cu, Li, Mn, Ni, Zn, or any combinations thereof.

3. The process of claim 1 or 2, wherein the REEs comprise La, Nd, Sm, Ce, Pr, Y, Tb, Er, Sc, Gd, Eu, Dy, or any combinations thereof.

4. The process of any one of claims 1 to 3, wherein recovering the metal powder comprises separating the fragmented waste into a coarse fraction and a fine fraction, the fine fraction comprising the metal powder.

5. The process of claim 4, wherein the fine fraction further comprises a low-density material comprising at least one of plastic and paper and recovering the metal powder further comprises separating the low-density material and a metal fraction from the fine fraction with a gravitational-based method.

6. The process of any one of claims 1 to 5, wherein the leaching of the REEs and the basic metals from the metal powder comprises simultaneously leaching the REEs and the basic metals by:
contacting the metal powder with a leaching solution to solubilize at least a portion of both the REEs and the basic metals, and to produce a first solid-liquid mixture comprising the REE-enriched leachate and the metal-depleted residual solid; and
separating the REE-enriched leachate and the metal-depleted residual solid by solid-liquid separation;
wherein the REE-enriched leachate further comprises the basic metals.

7. The process of claim 6, wherein the leaching solution comprises an inorganic acid.

8. The process of claim 7, wherein the leaching solution has an acid concentration between 0.5 N and 5 N.

9. The process of any one of claims 6 to 8, wherein a ratio of a weight of the metal powder to a volume of the leaching solution is between 50 g/L and 200 g/L.

10. The process of any one of claims 6 to 9, wherein the electronic waste consists of the spent batteries.

11. The process of any one of claims 6 to 10, wherein the leaching solution further comprises hydrogen peroxide, sodium metabisulfite or a combination thereof.

12. The process of any one of claims 1 to 5, wherein the leaching of the REEs and the basic metals from the metal powder comprises selectively leaching the REEs and the basic metals.

13. The process of claim 12, wherein selectively leaching the REEs and the basic metals comprises leaching the REEs prior to leaching the basic metals.

14. The process of claim 11 or 12, wherein the leaching of the REEs comprises:
contacting the metal powder with a first leaching solution to solubilize at least a portion of the REEs and to produce a first solid-liquid mixture comprising the REE-enriched leachate and a REE-depleted residual solid; and
separating the REE-enriched leachate and the REE-depleted residual solid by solid-liquid separation.

15. The process of claim 14, wherein the first leaching solution comprises an inorganic acid.

16. The process of claim 14 or 15, wherein the first leaching solution has an acid concentration between 0.2 N and 1 N.

17. The process of any one of claims 14 to 16, wherein a ratio of a weight of the metal powder to a volume of the first leaching solution is between 50 g/L and 200 g/L.

18. The process of any one of claims 14 to 17, wherein the leaching of the basic metals comprises:
contacting the REE-depleted residual solid with a second leaching solution to solubilize at least a portion of the basic metals and to produce a second solid-liquid mixture comprising the basic metal-enriched leachate and the metal-depleted residual solid; and
separating the basic metal-enriched leachate and the metal-depleted residual solid by solid-liquid separation.

19. The process of claim 18, wherein the second leaching solution comprises an inorganic acid and an oxidizing agent.

20. The process of claim 19, wherein the oxidizing agent comprises hydrogen peroxide.

21. The process of claim 19 or 20, wherein the second leaching solution comprises an amount of oxidizing agent being stoichiometrically sufficient to oxidize the basic metals present in metallic form in the metal powder.

22. The process of any one of claims 19 to 21, wherein the second leaching solution has an acid concentration between 1 N and 5 N.

23. The process of any one of claims 19 to 22, wherein the second leaching solution has a weight ratio of the oxidizing agent to the REE-depleted residual solid between 0.33 and 1.33.

24. The process of any one of claims 18 to 23, wherein a ratio of a weight of the REE-depleted residual solid to a volume of the second leaching solution is between 50 g/L and 200 g/L.

25. The process of any one of claims 1 to 24, wherein the metal powder further comprises precious metals, and the process further comprises leaching the precious metals from the metal-depleted residual solid to produce a precious metal-enriched leachate and a metal concentrate.

26. The process of claim 25, wherein the leaching of the precious metals comprises:
contacting the metal-depleted residual solid with a third leaching solution to solubilize at least a portion of the precious metals and to produce a third solid-liquid mixture comprising the precious metal-enriched leachate and the metal concentrate; and
separating the precious metal-enriched leachate and the metal concentrate by solid-liquid separation.

27. The process of claim 26, wherein the third leaching solution comprises a thiourea solution, a thiosulfate solution, a cyanide solution, or any mixtures thereof.

28. The process of claim 26 or 27, wherein the third leaching solution has a leaching agent concentration being between 0.10 and 0.50 grams of leaching agent per gram of the metal-depleted residual solid.

29. The process of any one of claims 26 to 28, wherein the leaching of the precious metal is performed according to a solids content between 50 and 200 grams of the metal-depleted residual solid per liter of the third leaching solution.

30. The process of any one of claims 25 to 29, further comprising extracting the precious metals from the precious metal-enriched leachate to produce a precious metals concentrate and a recyclable effluent.

31. The process of claim 30, wherein the extracting of the precious metals from the precious metal-enriched leachate comprises using at least one of activated carbon adsorption, cementation, ion-exchange, or electrodeposition.

32. The process of claim 30 or 31, wherein the precious metals comprise gold (Au), silver (Ag), platinum group metals (PGMs), and any combinations thereof.

33. The process of any one of claims 14 to 32, wherein the electronic waste comprises the spent batteries and the electronic equipment waste.

34. The process of any one of claims 1 to 33, wherein the extracting of the REEs comprises:
precipitating REE-hydroxides and/or REE-sulfates by adding a base solution to the REE-enriched leachate to produce a fourth solid-liquid mixture comprising the REE-containing component and the secondary leachate, wherein the REE-containing component comprises the REE-hydroxides and/or REE-sulfates; and
separating the REE-containing component and the secondary leachate by solid-liquid separation.

35. The process of any one of claims 1 to 33, wherein the extracting of the REEs comprises:
precipitating REE-hydroxides and/or REE-sulfates by adding a base solution to the metal-enriched leachate to produce a fourth solid-liquid mixture;
separating the REE-hydroxides and/or the REE-sulfates from the fourth solid-liquid mixture via solid-liquid separation;
re-dissolving the REE-hydroxides and/or the REE-sulfates in an acid solution to form a REE-containing solution; and
precipitating REE-oxalates by adding an oxalic acid and/or an oxalate salt to the REE-containing solution to produce a fifth solid-liquid mixture comprising the REE-oxalates; and
separating the REE-oxalates from the fifth solid-liquid mixture as the REE-containing component.

36. The process of claim 34 or 35, wherein the base solution is selected from a group consisting of sodium hydroxide (NaOH), potassium hydroxide (KOH), calcium hydroxide (Ca(OH)₂) and magnesium hydroxide (Mg(OH)₂).

37. The process of any one of claims 34 to 36, wherein the base solution further comprises a sulfate salt.

38. The process of any one of claims 1 to 33, wherein the extracting of the REEs comprises:
precipitating REE-oxalates by adding a sulfate salt to the REE-enriched leachate to produce a fourth solid-liquid mixture comprising the REE-oxalates and the secondary leachate; and
separating the REE-oxalates and the secondary leachate from the fourth solid-liquid mixture via solid-liquid separation as the REE-containing component.

39. The process of claim 37 or 38, wherein the sulfate salt is sodium sulfate (Na₂SO₄), potassium sulfate (K₂SO₄) or any mixtures thereof.

40. The process of any one of claims 34 to 39, further comprising calcining the REE-containing component to produce a REE oxides concentrate.

41. The process of any one of claims 1 to 40, further comprising mixing the basic-metal enriched leachate and the secondary leachate to form a metal-enriched leachate, and wherein the selective extracting of the basic metals is performed from the metal-enriched leachate.

42. The process of any one of claims 1 to 41, wherein selectively extracting the basic metals comprises successively extracting each one of the basic metals to produce each extracted component comprising one basic metal.

43. The process of any one of claims 1 to 42, wherein the basic metals comprise cadmium, cobalt and lithium, and the multiple extracted components produced by the selective extracting of the cadmium, cobalt and lithium comprise metallic cadmium (Cd), a cobalt oxide concentrate (CoO) and at least one of lithium carbonate (LiCO₃) and lithium phosphate (LiPO₄).

44. The process of any one of claims 1 to 42, wherein the basic metals comprise copper, zinc, cadmium, manganese, cobalt, nickel and lithium, and the multiple extracted components successively produced by the selective extracting of the copper, zinc, cadmium, manganese, cobalt, nickel and lithium comprise metallic copper (Cu), metallic zinc (Zn), metallic cadmium (Cd), a cadmium sulfide concentrate (CdS), a manganese carbonate concentrate (MnCO₃), a cobalt oxide concentrate (CoO), a nickel oxide concentrate (NiO), lithium carbonate (LiCO₃) and lithium phosphate (Li₃PO₄).

45. The process of any one of claims 1 to 44, wherein the electronic waste comprises spent batteries and the process further comprises inerting the spent batteries prior to fragmenting the electronic waste.

46. The process of claim 45, wherein the inerting of the spent batteries comprises placing the spent batteries in an aqueous saline or acidic solution, freezing the spent batteries using liquid nitrogen, or a combination thereof.

47. The process of any one of claims 1 to 46, wherein the leaching of the REEs and the basic metals from the metal powder comprises performing multiple successive acid leaching steps of the REEs and the basic metals.

48. The process of any one of claims 1 to 46, wherein the leaching of the REEs and the basic metals from the metal powder comprises performing at least one acid leaching of the REEs and basic metals and at least one washing of the metal-depleted residual solid with water.

49. A process for treating spent batteries comprising basic metals and rare earth elements (REE), the process comprising:
a) inerting the spent batteries;
b) fragmenting the spent batteries to reduce a size of thereof and produce a fragmented waste including a metal powder;
c) recovering the metal powder from the fragmented waste, wherein the metal powder comprises the REEs and the basic metals;
d) simultaneously leaching the REEs and the basic metals by contacting the metal powder with a leaching solution to solubilize at least a portion of both the REEs and the basic metals, and to produce a first solid-liquid mixture comprising a leachate and a metal-depleted residual solid, wherein the leachate comprises both the REEs and the basic metals;
e) separating the leachate and the metal-depleted residual solid by solid-liquid separation;
f) extracting the REEs from the leachate to produce a REE-containing component and a secondary leachate, wherein the secondary leachate comprises the basic metals;
g) selectively extracting the basic metals from the secondary leachate to produce multiple extracted components, each extracted component comprising at least one of the basic metals.

50. The process of claim 49, wherein the inerting of the spent batteries comprises one of placing the spent batteries in an aqueous saline or acidic solution or freezing the spent batteries using liquid nitrogen.

51. The process of claim 49 or 50, wherein the fragmenting of the spent batteries is performed in a non-oxidizing environment.

52. The process of 51, wherein the non-oxidizing environment comprises a nitrogen atmosphere.

53. The process of any one of claims 49 to 52, further comprising at least one feature of any one of claims 1 to 11 and 25 to 48.

54. The process of any one of claims 1 to 53, wherein the spent batteries are selected from the group consisting of alkaline Zn/MnO₂ batteries, Zn—C batteries, Ni—Cd batteries, Ni-MH batteries, Li-ion batteries, Li-M batteries, button cells, and any combinations thereof.

55. The process of any one of claims 1 to 54, wherein the electronic equipment waste comprise equipment pieces selected from the group consisting of laptops, televisions, CRT monitors, LCD monitors, LED monitors, cell phones, smartphones, electronic tablets, solar photovoltaic (PV) panels, traditional hard drives (HDD), solid-state drives (SSD), and any combinations thereof.
